(19) United States
(12) Patent Application Publication
(10) Pub. No.: US 2013/0339044 A1
(43) Pub. Date: Dec. 19, 2013

(54) MOBILE APPLICATIONS FOR RISK EVALUATION AND MITIGATION STRATEGY (REMS) PROGRAMS

(71) Applicant: Celgene Corporation, Summit, NJ (US)

(72) Inventors: Paul Bernard Sheehan, Chatham, NJ (US); Christopher J. Linzer, Annandale, NJ (US)

(21) Appl. No.: 13/917,986

(22) Filed: Jun. 14, 2013

Related U.S. Application Data
(60) Provisional application No. 61/660,169, filed on Jun. 15, 2012.

(51) Int. Cl. G06Q 10/06; G06Q 50/22

(52) U.S. Cl. CPC G06Q 10/0635; G06Q 50/22
USPC 705/2

(57) ABSTRACT

Applications for risk evaluation and mitigation strategy (REMS) are disclosed herein. Such applications may execute on devices operated by healthcare professionals, patients, pharmaceutical companies, pharmacies, third parties and other parties. One or more of such devices may be mobile devices, thereby allowing information to be presented and obtained at a variety of times and locations. One or more different features may be made available to each of such parties as necessary to assist in their desired scope of interaction with a REMS program. Applications on client devices may communicate with one or more servers to send and receive information associated with REMS related features.

### CROSS REFERENCE TO RELATED APPLICATIONS

This application claims the benefit of U.S. Provisional Application No. 61/660,169, filed Jun. 15, 2012, the entirety of which is incorporated herein by reference.

### TECHNICAL FIELD

The disclosure herein relates to the field of risk evaluation and mitigation strategy (REMS) for pharmaceutical products. More specifically, the disclosure relates to mobile and other applications for presenting, collecting, recording, organizing and performing other tasks associated with REMS related information.

### BACKGROUND

A central inquiry relating to pharmaceutical product approval is a determination of whether the pharmaceutical product's benefits will outweigh its risks. As part of this determination, a program referred to as risk evaluation and mitigation strategy (REMS) may be required. A significant portion of REMS related legislation was included as part of the Food and Drug Administration Amendments Act (FDAAA) of 2007. A REMS plan may include elements such as, for example, a medication guide, a communication plan, elements to assure safe use, an implementation plan, and a timetable for submission of assessments. REMS plans may often be employed or required in connection with new drug applications (NDAs) and/or supplemental new drug applications (sNDAs).

In order to comply with REMS requirements, it may be necessary to provide and obtain a great deal of information to and from a number of parties. Additionally, in order to further reduce risk and generally improve the usage and effects of a pharmaceutical product, it may also be desirable to provide and obtain additional REMS related information to and from such parties, even if such additional information is not an explicit component of the REMS requirements. Such parties may include, for example, healthcare professionals, patients, pharmaceutical companies, pharmacies and other parties.

In recent years, there has been rapid growth in the use and quality of mobile computing devices such as, for example, smart phones, tablet computers and laptops. Such mobile computing devices have become increasingly popular because they enable information to be provided to and obtained from users at almost any location and at almost any time. Such devices also enable information to be presented and organized in an efficient manner that is easy for users to understand and navigate.

Because REMS requires a great deal of information to be presented to and obtained from a number of different parties at various times and locations, the REMS process could be enhanced and improved through the use of mobile devices. However, it seems that conventional REMS related technology has not yet sufficiently embraced the use of such mobile devices.

### SUMMARY

Applications for risk evaluation and mitigation strategy (REMS) are disclosed herein. Such applications may execute on devices operated by healthcare professionals, patients, pharmaceutical companies, pharmacies, third parties and other parties. One or more of such devices may be mobile devices, thereby allowing information to be presented and obtained at a variety of times and locations. One or more different features may be made available to each of such parties as necessary to assist in their desired scope of interaction with a REMS program. Applications on client devices may communicate with one or more servers to send and receive information associated with REMS related features.

According to an aspect of the disclosure, a REMS application may execute on a device operated by a healthcare professional. This application may first attempt to verify an identity of the healthcare professional. Upon receiving such verification, the application may present the healthcare professional with a set of available products for which REMS features may be presented. Upon receiving a selection of one of the available products, the application may attempt to confirm that the healthcare professional is authorized to access REMS features associated with the selected product. Upon receiving such confirmation, the application may then present the REMS features associated with the selected product to the healthcare professional. For example, the REMS features available to the healthcare professional may comprise one or more of prescribing information, educational materials, training, survey and knowledge assessment, patient registration, patient resources, decision aid, prescription form creation and news. At least some of these features may be made available only to healthcare professionals.

The healthcare professional may use the application to perform and/or record various actions with respect to the REMS features. For example, the healthcare professional may use the REMS features to register patients for the selected product. The application may also transmit indications that actions have been performed by the healthcare professional and other associated information so that such information can be recorded in a central database. For example, the application may transmit an indication that a patient has been registered for the selected product. This may then be recorded in a central database, thereby allowing the registered patient to access certain REMS features for the selected product. Additionally, the healthcare professional may, for example, indicate that various materials should be electronically delivered or otherwise made available to the patient.

According to another aspect of the disclosure, a REMS application may execute on a device operated by a patient. Upon receiving an indication that the user of the application is a patient, the application may present the patient with a set of available products for which REMS features may be presented. Upon receiving a selection of one of the available products, the application may then present a set of patient-accessible REMS features associated with the selected product to the patient. The patient-accessible REMS features may be different than those available to the healthcare professional. For example, the patient-accessible REMS features may comprise one or more of patient education material, patient support information and a reimbursement assistance application, indication specific content, information from disease appropriate patient advocacy groups, a patient medication guide and a patient survey. The patient may be required to be previously registered by a healthcare professional in order to access at least some of the patient-accessible REMS features.

The patient may use the application to perform and/or record various actions with respect to the REMS features. For example, the patient may use the REMS features to indicate that he or she has reviewed necessary materials, performed various testing procedures, record the results of such procedures and indicate that the patient understands various associated risks. This information may then be transmitted to one or more servers for recording in a central database.

The foregoing summarizes only a few aspects of the present disclosure and is not intended to be reflective of the full scope of the present disclosure. Additional features and advantages of the disclosure are set forth in the following description, may be apparent from the description, or may be learned by practicing the invention. Moreover, both the foregoing summary and following detailed description are exemplary and explanatory and are intended to provide further explanation of the disclosure.

### BRIEF DESCRIPTION OF THE DRAWINGS

FIG. 1 is a block diagram of an exemplary computing device for use in accordance with the present disclosure;

FIG. 2 depicts an exemplary architecture for installation of a REMS exchange application;

FIG. 3A depicts an exemplary standard communication architecture for a REMS exchange application;

FIG. 3B depicts an exemplary cloud communication architecture for a REMS exchange application;

FIG. 4 is a flowchart depicting an exemplary method for presenting REMS related features to a healthcare professional;

FIG. 5 is a screen shot depicting an exemplary REMS application home page;

FIG. 6 is a screen shot depicting an exemplary healthcare professional login page;

FIG. 7 is a screen shot depicting an exemplary healthcare professional product selection page;

FIG. 8 is a screen shot depicting an exemplary product code entry page;

FIG. 9 is a screen shot depicting an exemplary product page with a retracted sliding menu;

FIG. 10 is a screen shot depicting an exemplary product page with an expanded sliding menu;

FIG. 11 is a screen shot depicting an exemplary prescribing information page;

FIG. 12 is a screen shot depicting an exemplary educational materials page;

FIG. 13 is a screen shot depicting an exemplary training and knowledge assessment page;

FIG. 14 is a screen shot depicting an exemplary patient registration page;

FIG. 15 is a screen shot depicting an exemplary patient search page;

FIG. 16 is a screen shot depicting an exemplary resource items selection page;

FIG. 17 is a screen shot depicting an exemplary decision aid page;

FIG. 18 is a screen shot depicting another exemplary patient search page;

FIGS. 19A-B are screen shots depicting exemplary prescription form creation pages;

FIG. 20 is a screen shot depicting an exemplary news page;

FIG. 21 is a flowchart depicting an exemplary method for presenting REMS related features to a patient;

FIG. 22 is a screen shot depicting an exemplary patient product selection page;

FIG. 23 is a screen shot depicting an exemplary product page with a retracted sliding menu;

FIG. 24 is a screen shot depicting an exemplary product page with an expanded sliding menu;

FIG. 25 is a screen shot depicting an exemplary patient personal information entry page;

FIG. 26 is a screen shot depicting an exemplary survey product selection page page;

FIG. 27 is a screen shot depicting an exemplary patient survey response page;

FIG. 28 is a screen shot depicting an exemplary patient medication guide page;

FIG. 29 is a screen shot depicting an exemplary re-imbursement page;

FIG. 30 is a screen shot depicting an exemplary patient advocacy page;

FIG. 31 is a screen shot depicting an exemplary news page;

FIG. 32 is a flowchart depicting an exemplary method for interacting with a healthcare professional; and

FIG. 33 is a flowchart depicting an exemplary method for interacting with a patient.

### DETAILED DESCRIPTION OF ILLUSTRATIVE EMBODIMENTS

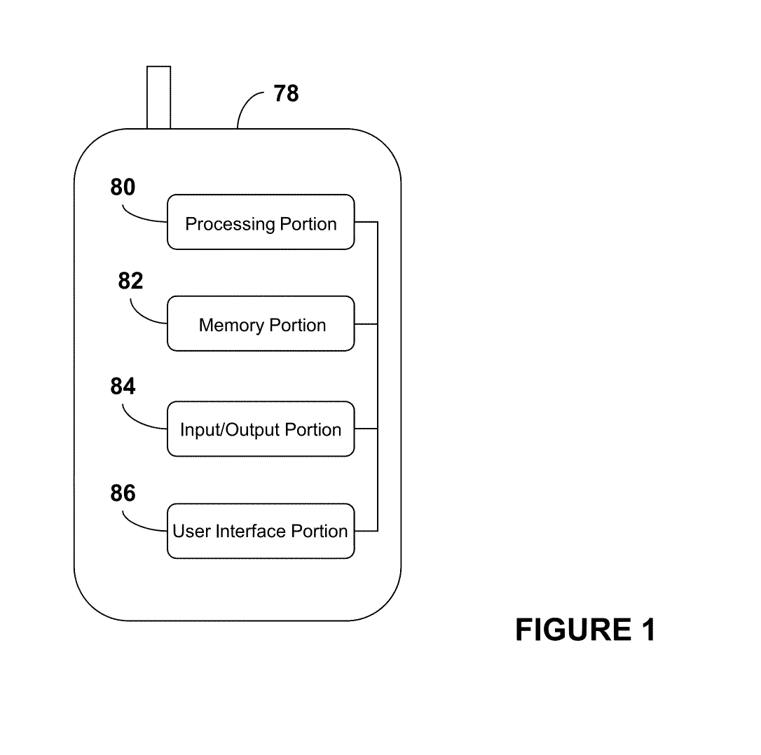

FIG. 1 is a block diagram of an exemplary computing device 78 for use in accordance with the present disclosure. In an example configuration, computing device 78 is a mobile wireless device. The computing device 78 can comprise any appropriate device, examples of which include a desktop computing device, a server computing device, a portable computing device, such as a laptop, a personal digital assistant (“PDA”), a portable phone (e.g., a cell phone or the like, a smart phone, a video phone), a portable email device, or a combination thereof. The computing device 78 can include devices that are not typically thought of as portable, such as, for example, a public computing device, a set top box, or the like.

In an example configuration, the computing device 78 comprises a processing portion 80, a memory portion 82, an input/output portion 84, and a user interface (UI) portion 86. It is emphasized that the block diagram depiction of computing device 78 is exemplary and not intended to imply a specific implementation and/or configuration. The processing portion 80, memory portion 82, and input/output portion 84 are coupled together to allow communications therebetween.

In various embodiments, the input/output portion 84 comprises a receiver of the computing device 78, a transmitter of the computing device 78, or a combination thereof. The input/output portion 84 is capable of receiving and/or providing information pertaining to communicate a network such as, for example, the Internet.

Depending upon the exact configuration and type of processor, the memory portion 82 can be volatile (such as some types of RAM), non-volatile (such as ROM, flash memory, etc.), or a combination thereof. The mobile computing device 78 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the mobile computing device 78.

The computing device 78 also can contain a UI portion 86 allowing a user to communicate with the computing device 78. The UI portion 86 can provide the ability to control the computing device 78, via, for example, buttons, soft keys, voice actuated controls, a touch screen, movement of the mobile computing device 78, visual cues (e.g., moving a hand in front of a camera on the mobile computing device 78), or the like. The UI portion 86 can provide visual information (e.g., via a display), audio information (e.g., via speaker), mechanically (e.g., via a vibrating mechanism), or a combination thereof. In various configurations, the UI portion 86 can comprise a display, a touch screen, a keyboard, an accelerometer, a motion detector, a speaker, a microphone, a camera, a tilt sensor, or any combination thereof. The UI portion 86 can comprise means for inputting biometric information, such as, for example, fingerprint information, retinal information, voice information, and/or facial characteristic information.

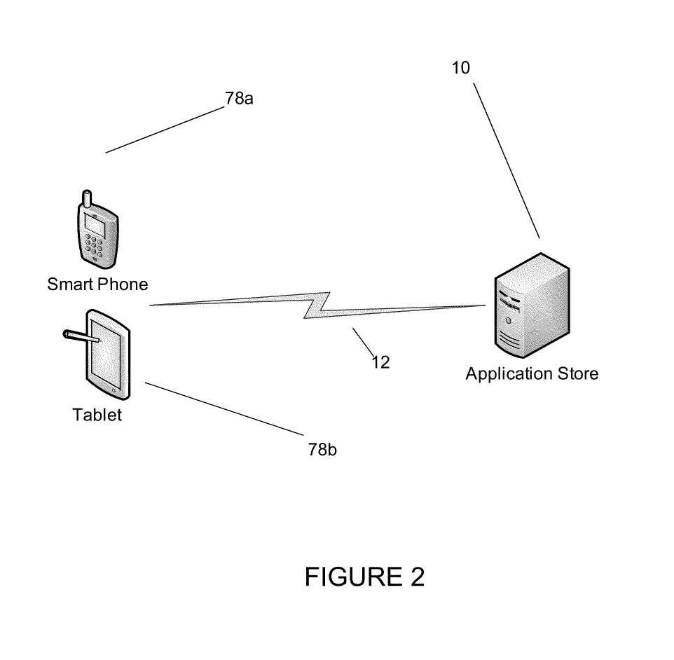

FIG. 2 depicts an exemplary architecture for installation of a REMS exchange application. A computing device such as smart phone 78a or tablet 78b may communicate with an application store 10 via a network 12 such as, for example, the Internet. Application store 10 may be, for example, a company specific store or an open device specific store.

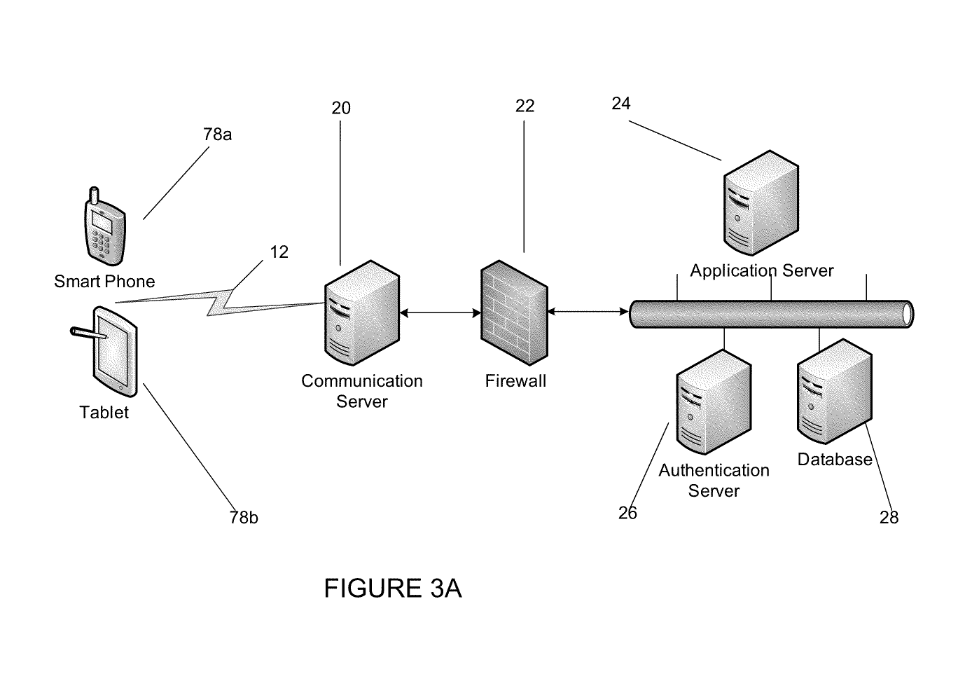

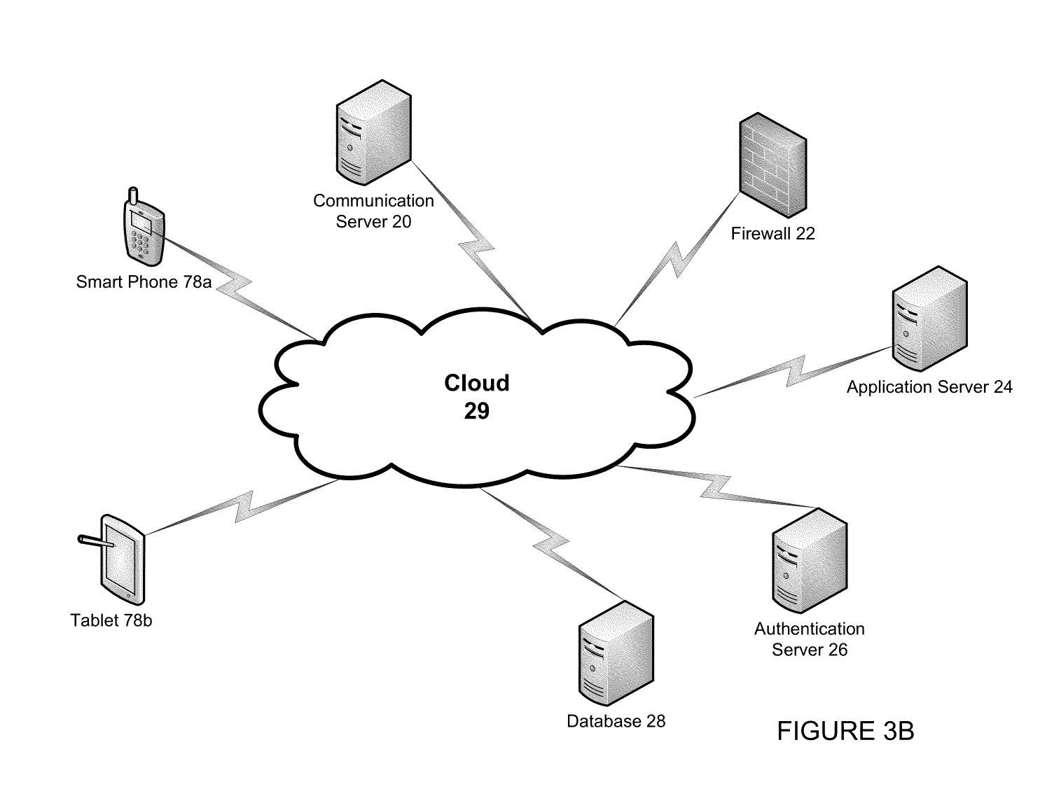

FIG. 3A depicts an exemplary standard communication architecture for a REMS exchange application. The REMS servers depicted in FIG. 3A may be operated in whole or in part by, for example, a pharmaceutical company and/or new drug application (NDA) or supplemental new drug application (sNDA) holder, a Risk Management Administrator (RMA), a government agency, another third party, or by any combination of any of the above entities. Any of the components in FIG. 3A may also be operated by an Internet Service Provider (ISP) or other entity on behalf of any of the entities listed above or others.

Once the REMS exchange application has been installed onto a computing device such as smart phone 78a or tablet 78b, it will communicate with one or more REMS communication servers 20 via a network 12 such as, for example, the Internet. The REMS communication servers 20 may in turn communicate via a firewall 22 with one or more application servers 24, one or more authentication servers 26, and a database 28. Database 28 may be used, for example, to store information regarding REMS features that are made available to the REMS exchange application. Database 28 may also be used, for example, to store information obtained from parties such as healthcare professionals and patients via the REMS exchange application.

In addition to or in place of the exemplary standard architecture depicted in FIG. 3A, a number of other types of communication architectures and/or features may be employed. Such other architectures and/or features may include, for example, any combination of hosted services, cloud services, network-based hosted services, Software as a Service (SaaS), Communications as a Service (CaaS), virtual services, on-demand services, public switched telephone network (PSTN) services and others.

To illustrate some possibilities of such other architectures and/or features, FIG. 3B depicts an exemplary cloud communication architecture for a REMS exchange application. As with FIG. 3A, the REMS servers depicted in FIG. 3B may also be operated in whole or in part by, for example, a pharmaceutical company and/or new drug application (NDA) or supplemental new drug application (sNDA) holder, a Risk Management Administrator (RMA), a government agency, another third party, or by any combination of any of the above entities. Any of the components in FIG. 3B may also be operated by an Internet Service Provider (ISP) or other entity on behalf of any of the entities listed above or others.

As shown in FIG. 3B smart phone 78a and tablet 78b (which may execute the REMS exchange application), communication servers 20, application servers 24, one or more authentication servers 26, and database 28 all communicate via cloud 29. Cloud 29 may be, for example, a public, private, hybrid or other cloud. Cloud 29 may include any number of networks and sub-networks. A public switched telephone network (PSTN) may also be employed in conjunction with cloud 29. Devices such as gateways, switches, routers and other components may be employed to direct communications through cloud 29. Cloud 29 may be beneficial for enabling efficient communication with clients, servers, databases and other components or operations spread throughout various different national, international and/or global locations. Such an infrastructure may assist in enabling what many refer to as “follow-the sun” service.

### Exemplary Features for Healthcare Professionals

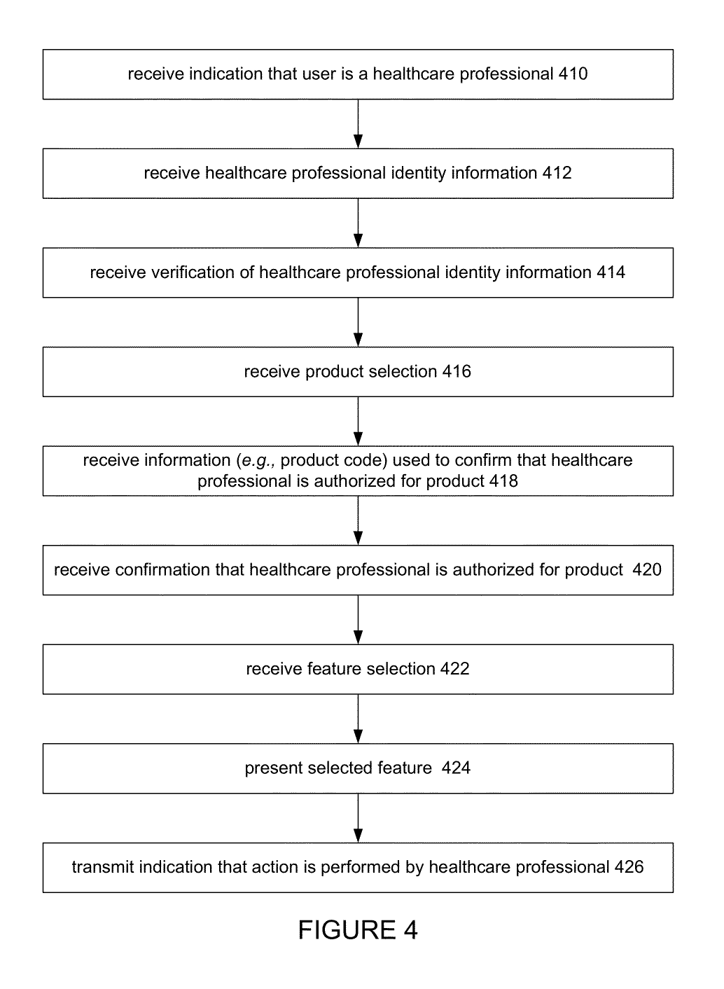

FIG. 4 is a flowchart depicting an exemplary method for presenting REMS related features to a healthcare professional such as, for example, a doctor or any professional authorized to prescribe pharmaceutical products. The acts depicted in FIG. 4 may, although need not necessarily, be performed by REMS exchange client software. Such software may, although need not necessarily, be installed on a mobile device such as a smart phone or tablet computer. Such software may be purchased or obtained via an architecture such as depicted in FIG. 2 and described above. Such software may communicate with one or more REMS servers via an architecture such as depicted in FIGS. 3A and 3B and described above.

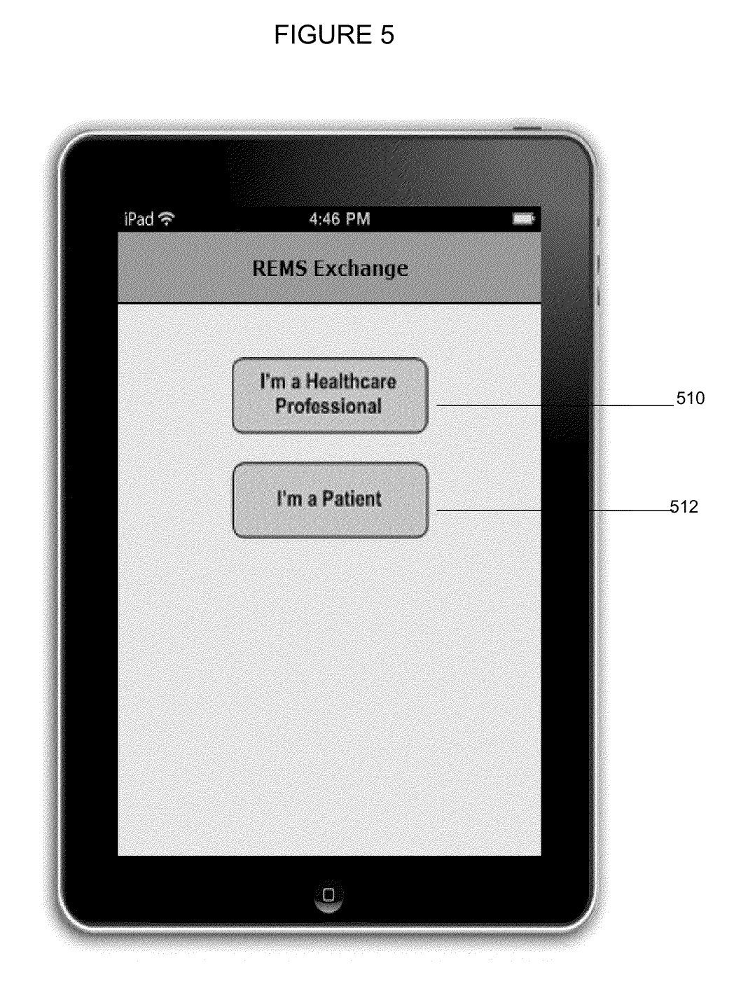

At act 410 of FIG. 4, an indication is received that a user is a healthcare professional. Such an indication may be received via a REMS exchange application home page. FIG. 5 depicts an exemplary REMS exchange application home page. As shown in FIG. 5, the user may select button 510 to indicate that he is a healthcare professional, while the user may select button 512 to indicate that he is a patient. Patient related features of the REMS exchange application are described later within this document.

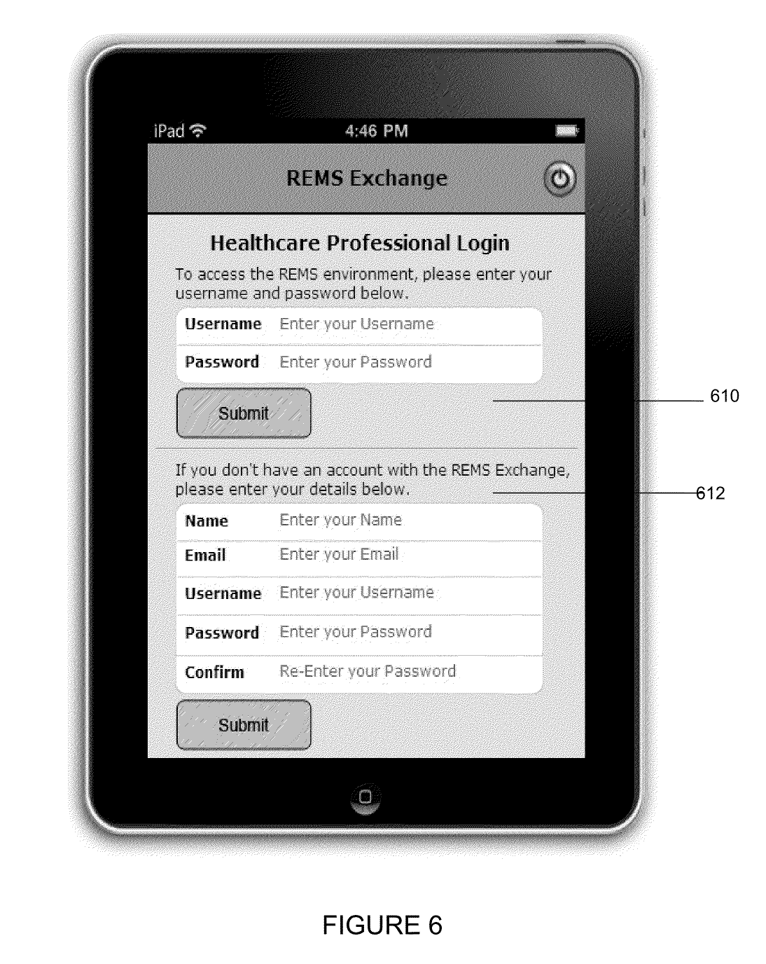

At act 412 of FIG. 4, healthcare professional identity information is received. Such identity information may include, for example, a user name and password. Additionally, for example, biometric identity information such as a fingerprint or eye scan may be used if a user device is capable of obtaining such information. Such healthcare professional identity verification information may be obtained via a healthcare professional login page. FIG. 6 depicts an exemplary healthcare professional login page. As shown in FIG. 6, if the user has previously registered with the REMS exchange, then the user can enter his username and password via returning user page section 610. Once entered, this information may be submitted to the REMS severs for verification. The REMS servers may match the entered username and password with a stored username and password. The REMS servers may then send back to the client an indication of whether or not the user has been verified. If the verification has failed, the user may be prompted to re-enter the identity verification information or the user may be denied further access to the REMS exchange.

On the other hand, if the user hasn't previously registered, he can create a user account via new user page section 612. The user can create an account by entering information such as his name and email and creating an associated username and password. The user may also indicate a preferred language such as, for example, English. Once entered, this information may be submitted to the REMS severs for storage.

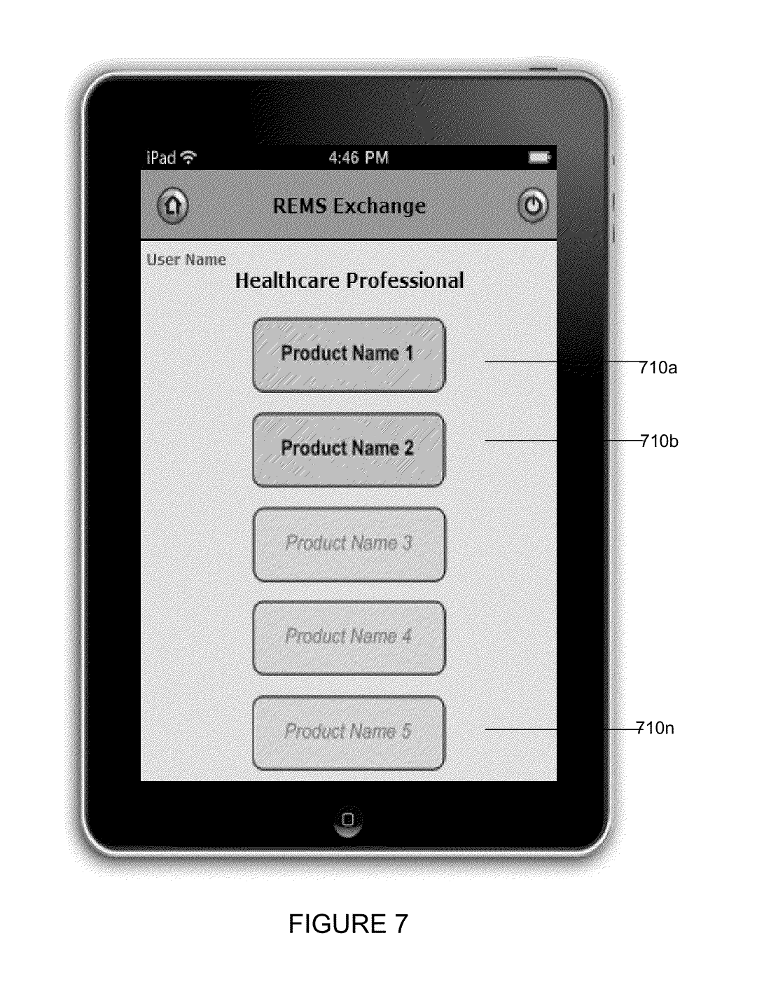

Once the user has been registered or a verification of the identity information has been received (act 414), the REMS servers may send to the client a list of available pharmaceutical products for which REMS related features are available. Then, at act 416, a selection of an available product is received. The selection of an available product may be obtained via a product selection page. FIG. 7 depicts an exemplary healthcare professional product selection page. As shown in FIG. 7, buttons 710a-n are displayed, each corresponding to a particular product, and a product may be selected, for example, by pushing its corresponding button. The available products may be, for example, new drug application (NDA) or supplemental new drug applications (sNDA) products. Additionally, each available product selection may correspond to only a single product or to a class or other grouping of products.

After receiving a product selection, the healthcare professional may be prompted for information used to confirm that he is authorized to access the selected product features. This information is received at act 418. This information may include, for example, a product code that corresponds to the selected product. The product code may, for example, be provided to the healthcare professional by a pharmaceutical company. Procedural controls within the pharmaceutical company may ensure that unique codes are only delivered to appropriate healthcare professionals. Each code may be unique to a healthcare professional, and may provide access to a REMS features for either a single product or a grouping of products.

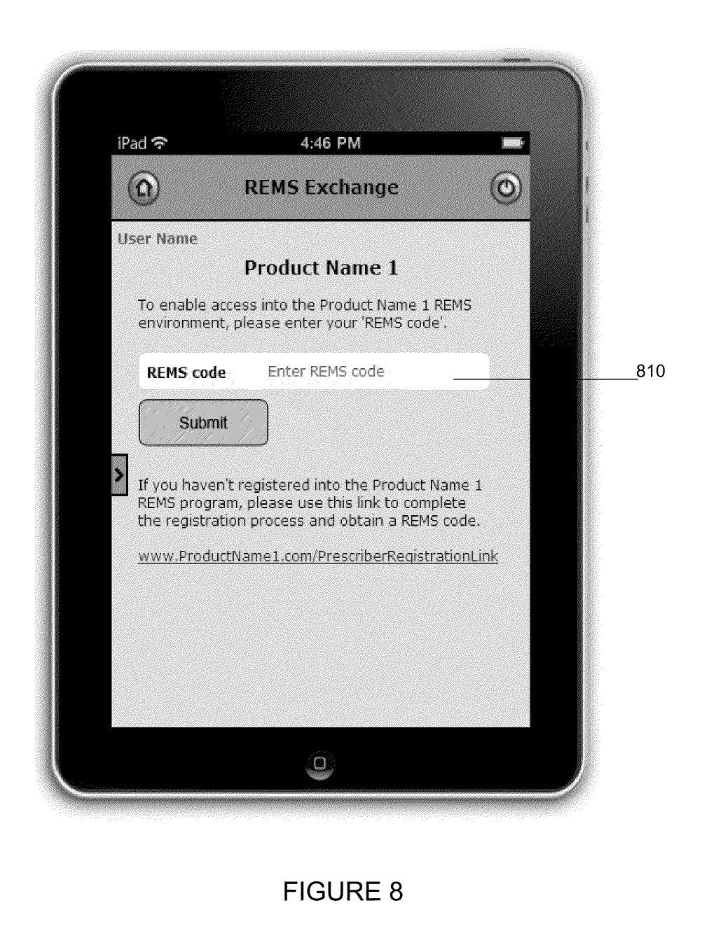

The product code may be obtained via a product code entry page. FIG. 8 depicts an exemplary product code entry page. As shown in FIG. 8, the product code may be entered via product code entry field 810. Upon being entered, the product code or other product authorization confirmation may be sent to the REMS servers. The REMS servers may then verify the product authorization confirmation. For example, the REMS servers may compare the product code entered by the user with a stored product code corresponding to the selected product. The REMS servers may then send back to the client an indication of whether or not the product authorization confirmation has been verified. If the verification has failed, the user may be prompted to re-enter the product code or the user may be denied access to the product's features.

If a confirmation of the product code or other product authorization information has been received (act 420), then one or more available REMS features associated with the selected product may be presented to the healthcare professional. Information regarding these features may be transmitted from the REMS servers to the client device. The information may be transmitted to the client device upon confirmation of the product authorization information and/or at other times such as, for example, via periodic updates. The information may also be stored locally at the client device.

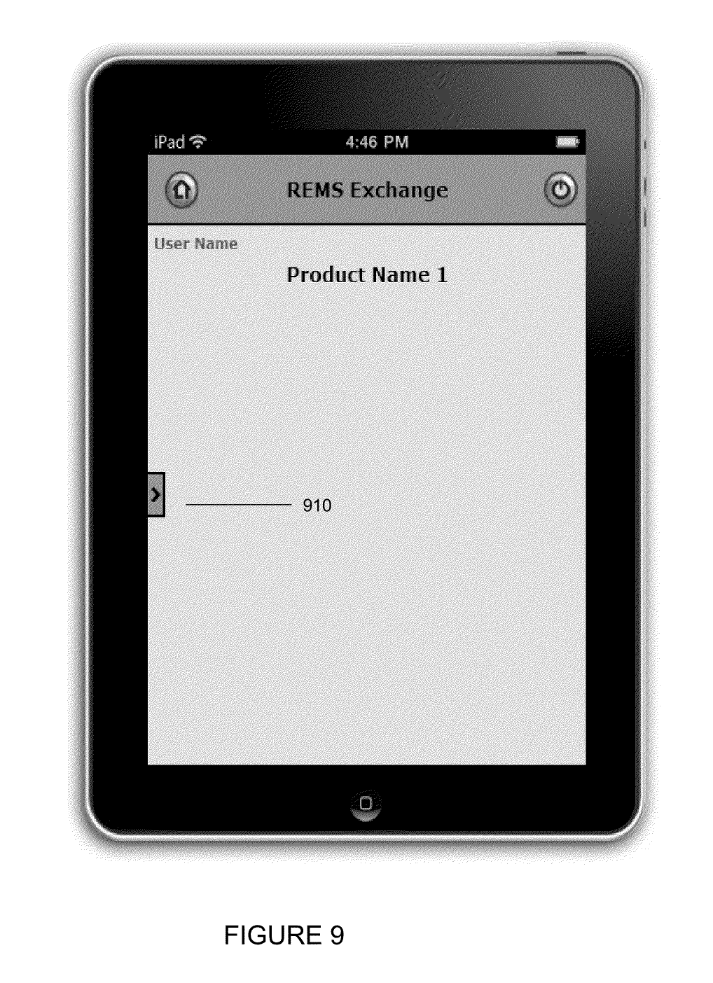

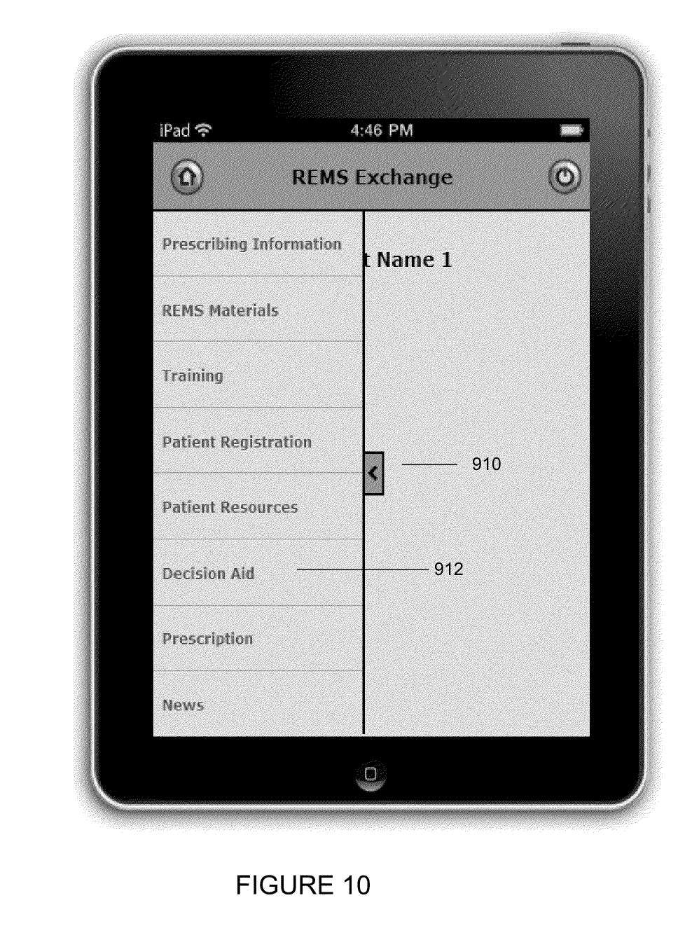

The REMS features may be presented to the user via, for example, a product page with a sliding menu. FIG. 9 depicts an exemplary product page with a retracted sliding menu. The retracted sliding menu can be expanded by, for example, pressing on and dragging menu activation button 910 to the right. FIG. 10 depicts an exemplary product page with an expanded sliding menu 912. The expanded sliding menu can be retracted by, for example, pressing on and dragging menu activation button 910 to the left. As shown in FIG. 10, sliding menu 912 lists a number of available REMS features including, for example, prescribing information, educational materials (referred to in FIG. 10 as “REMS materials”), training, survey and knowledge assessment, patient registration, patient resources, decision aid, prescription form creation and news. Each such REMS feature may be selected by, for example, pressing on the corresponding menu button.

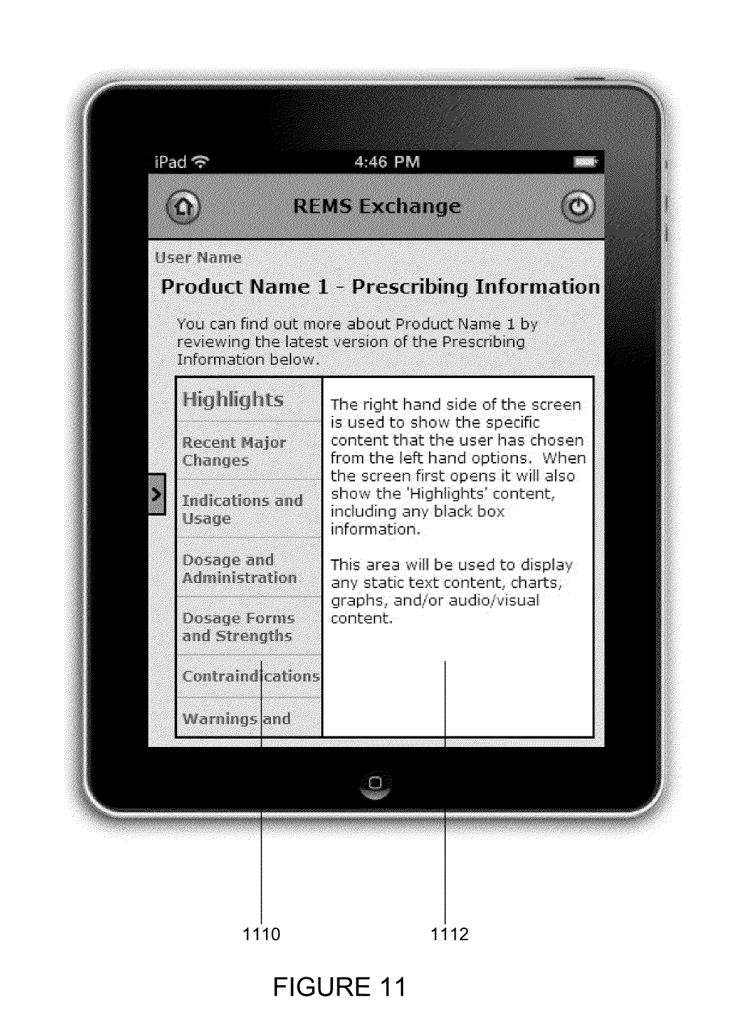

When a selection of one of the available REMS features is received from the healthcare professional (act 426), the selected REMS feature may then be presented to the healthcare professional at act 424. For example, the healthcare professional may select the prescribing information feature. The prescribing information feature may be presented to the healthcare professional via, for example, a prescribing information page. FIG. 11 depicts an exemplary prescribing information page. As shown in FIG. 11, the exemplary prescribing information page includes a prescribing information menu 1110 and a prescribing information presentation area 1112. The prescribing information menu 1110 may list available prescribing information options such as, for example, highlights, recent major changes, indications and usage, dosage and administration, dosage forms and strengths, contradictions, warnings and other information. The prescribing information may relate to a particular product or to a product class including multiple products. The prescribing information may include FDA approved product prescribing Information, and/or it may include FDA Office of Prescription Drug Promotion approved audio or video material targeted for healthcare professionals. After a particular item in prescribing information menu 1110 has been selected, prescribing information presentation area 1112 may be used to display information corresponding to the selected menu item. Prescribing information presentation area 1112 may display content such as, for example, text, charts, graphs, photos, video, other audio/visual content and other information.

When the healthcare professional performs an action with respect to one of the available REMS features, an indication of the action may be sent to the REMS servers at act 426. For example, when a healthcare professional accesses any of the prescribing information features, an electronic communication that indicates this action by the healthcare professional may be sent to the REMS exchange servers. For example, this indication may be sent either directly or indirectly to an RMA computer system to record the activity. The communication may include information such as, for example, user name, date, time, IP address, content viewed, duration and other information. Controls may be employed within the software to ensure that the healthcare professional has sufficiently interacted with the corresponding feature before the indication is sent. For example, if the healthcare professional is presented with a video, the software may first determine that the entire video has been played before sending the indication to the servers.

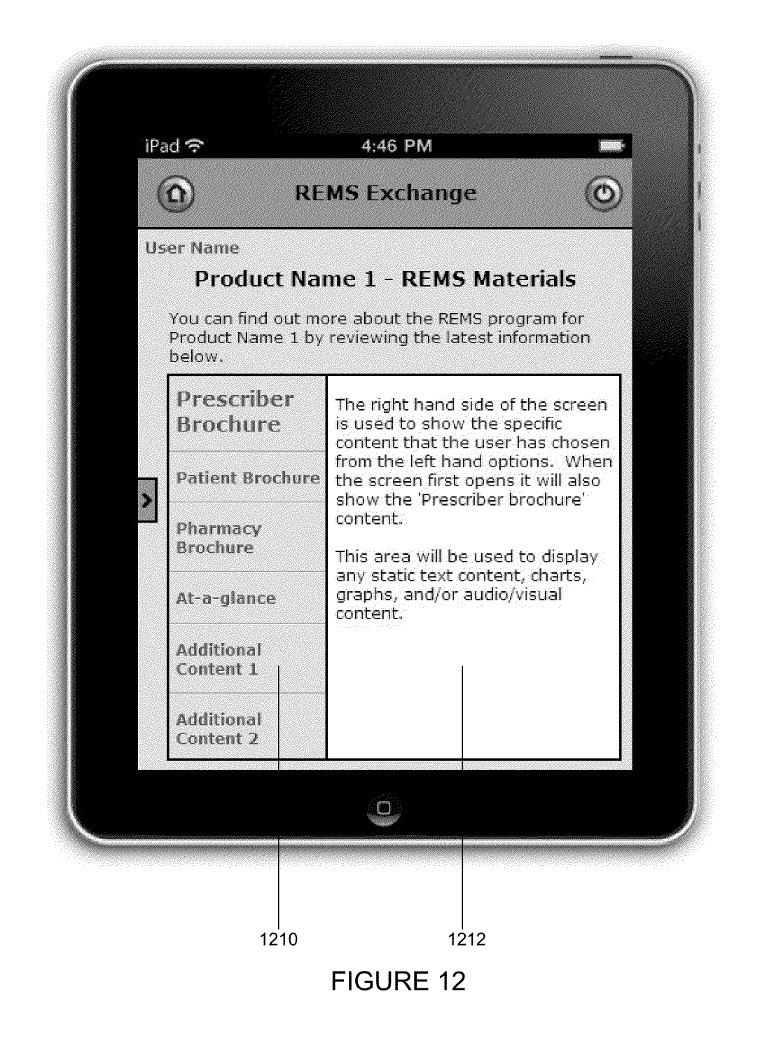

As another example of presentation of selected REMS features (act 424), the healthcare professional may select the educational materials feature (referred to in FIGS. 10 and 12 as “REMS materials”). The educational materials feature may be presented to the healthcare professional via, for example, an educational materials page. FIG. 12 depicts an exemplary educational materials page. As shown in FIG. 12, the exemplary educational materials page includes an educational materials menu 1210 and an educational materials presentation area 1212. The educational materials menu 1210 may list available educational materials options such as, for example, a prescriber brochure, a patient brochure, a pharmacy brochure, at-a-glance information and other information. The educational materials may relate to a particular product or to a product class including multiple products. After a particular item in educational materials menu 1210 has been selected, educational materials presentation area 1212 may be used to display information corresponding to the selected menu item. Educational materials presentation area 1212 may display content such as, for example, text, charts, graphs, photos, video, other audio/visual content and other information.

As another example of sending an indication of action performance by a healthcare professional (act 426), an electronic communication may be sent to the REMS servers when a healthcare professional accesses any of the educational materials to indicate this action by the healthcare professional. This indication may be similar to the indication for prescribing information described in detail above.

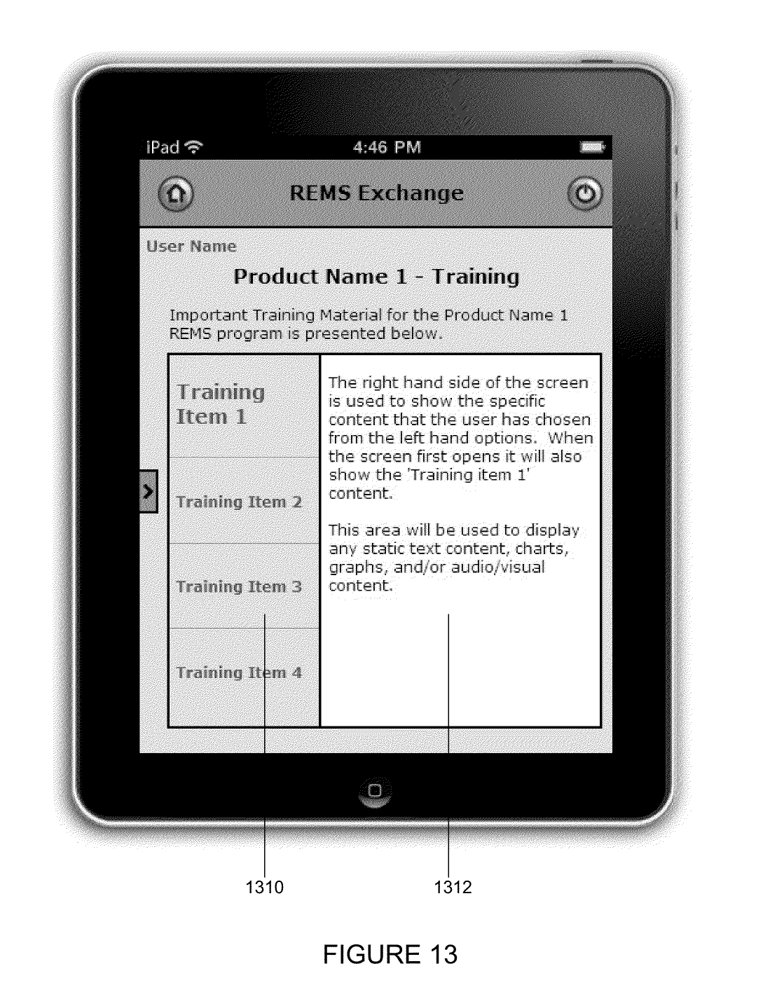

As another example of presentation of selected REMS features (act 424), the healthcare professional may select the training and knowledge assessment features. Healthcare professionals will select these features to complete any required REMS training and/or knowledge assessments, which may, for example, be a pre-requisite for prescribing the REMS product, or may, for example, be a reoccurring time-based activity. The knowledge assessment may, for example, take the form of a multiple choice quiz. The training and knowledge assessment features may be presented to the healthcare professional via, for example, a training and knowledge assessment page. FIG. 13 depicts an exemplary training and knowledge assessment page. As shown in FIG. 13, the exemplary training and knowledge assessment page includes a training and knowledge assessment menu 1310 and a training and knowledge assessment presentation area 1312. The training and knowledge assessment menu 1310 may list available training and knowledge assessment items. After a particular item in training and knowledge assessment menu 1310 has been selected, training and knowledge assessment presentation area 1312 may be used to display information corresponding to the selected menu item. Training and knowledge assessment presentation area 1312 may display content such as, for example, text, charts, graphs, photos, video, other audio/visual content and other information.

As another example of sending an indication of action performance by a healthcare professional (act 426), responses to training and knowledge assessment items may be electronically transmitted to the REMS servers (including, for example, an RMA computer system) for evaluation. For example, responses to a multiple choice quiz may be sent to the REMS servers for evaluation. The communication may include information such as, for example, user name, date, time, IP address, quiz name and other information. The REMS servers may return to the client a response indicating the success or failure of the participant's REMS knowledge assessment. If the participant achieved a passing grade then the RMA computer system may, for example, provide a unique key code that will be used in other REMS electronic transactions to indicate that the healthcare professional is qualified to conduct such a transaction.

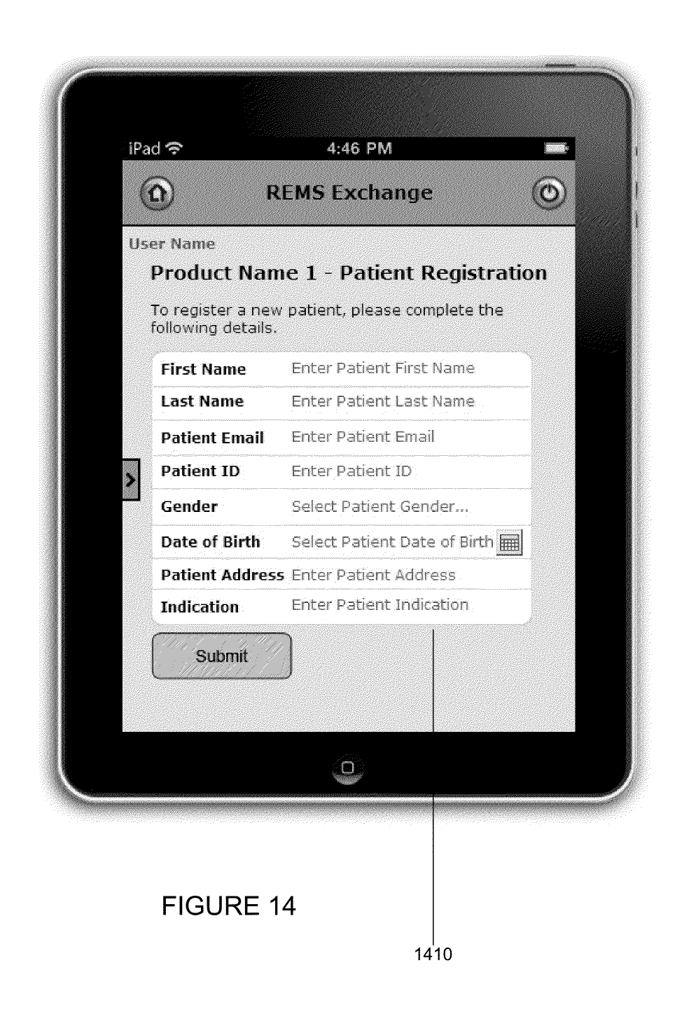

As another example of presentation of selected REMS features (act 424), the healthcare professional may select the patient registration feature. Healthcare professionals may use this feature to register a patient into a product or class specific REMS program. The patient registration feature may be presented to the healthcare professional via, for example, a patient registration page. FIG. 14 depicts an exemplary patient registration page. As shown in FIG. 14, the exemplary patient registration page includes registration information input fields 1410 which allow the healthcare professional to input registration information such as, for example, patient name (title, first, last), patient email, patient ID number, patient gender, patient date of birth age, patient address and patient indication (such as a description or by using, for example, the ICD-9 identification system). Other information that may be obtained during the patient registration may include, for example, prescriber userid, patient reproductive status, patient phone, patient social security number, date, time, IP address and other relevant information.

As another example of sending an indication of action performance by a healthcare professional (act 426), information obtained during the registration process may be electronically delivered to the REMS servers (including, for example, an RMA computer system) for processing. The REMS servers may then return an electronic message to the client application indicating whether the registration request was successful or not, along with any appropriate messages that should be displayed to the healthcare professional.

As another example of presentation of selected REMS features (act 424), the healthcare professional may select the patient resources feature. Healthcare professionals may use this feature to select specific content for delivery to one of their patients. While examples involving electronic (i.e., email) based delivery are described below, other forms of electronic or non-electronic delivery (i.e., regular mail) may also be used.

The Healthcare professional may first use this feature to search for a previously registered patient. If the application finds a matching patient, then the matching patient may be displayed on the screen. The healthcare professional may then use this feature to indicate which of the patient resource items are to be delivered to the patient. The healthcare professional may also confirm the patient's email address. The application may then deliver the selected resource items to the patient. For example, the selected resource items may be delivered via a single email containing all of the selected content. The application may maintain a history of content delivered to a patient, and may provide the ability to manually or automatically re-send the information if the materials are updated in the future.

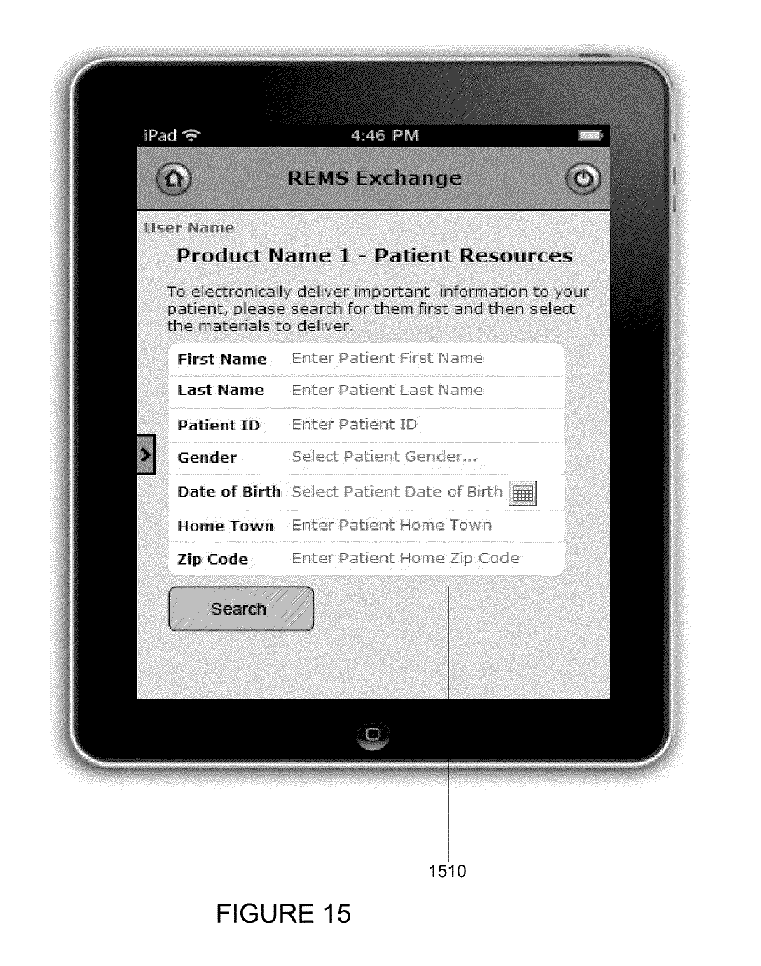

The healthcare professional may search for a registered patient via, for example, a patient search page. FIG. 15 depicts an exemplary patient search page. As shown in FIG. 15, the exemplary patient search page includes patient search input fields 1510 which allow the healthcare professional to input patient search information such as, for example, name, identification number, gender, date of birth, home town, zip code.

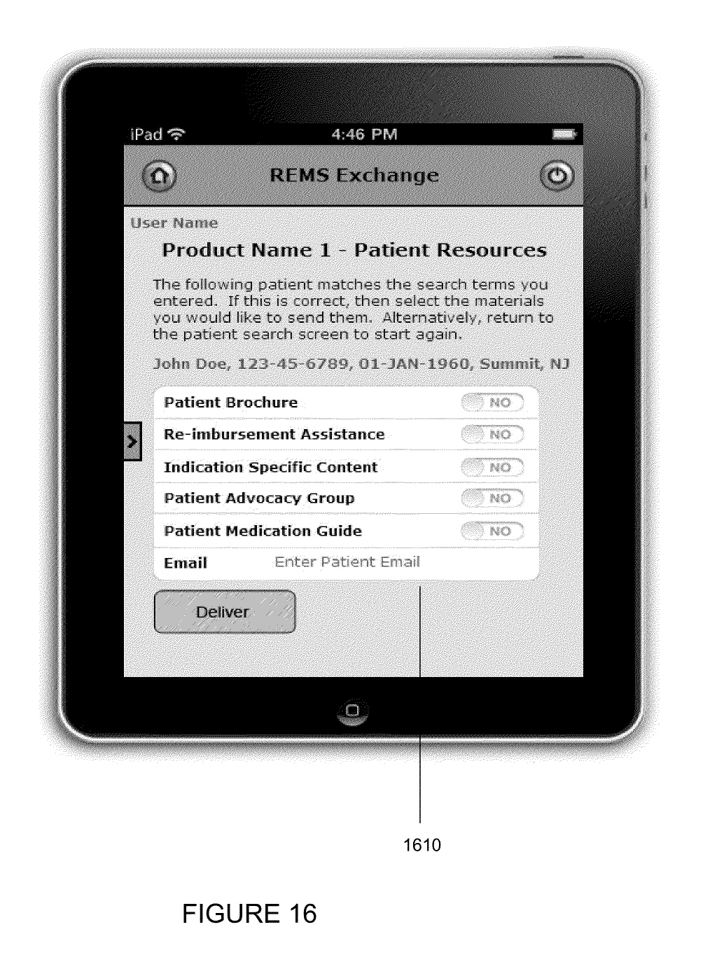

The healthcare professional may select resource items for delivery via, for example, a resource items selection page. FIG. 16 depicts an exemplary resource items selection page. As shown in FIG. 16, the exemplary resource items selection page includes resource items selection fields 1610 which allow the healthcare professional to select particular resource items for delivery such as, for example, a patient brochure, re-imbursement assistance, indication specific content, patient advocacy group material and a patient medication guide. Resource items selection fields 1610 also include a field for confirming the patient's email address.

As another example of sending an indication of action performance by a healthcare professional (act 426), an indication of the resource items selected for delivery may be sent to the REMS servers (including, for example, an RMA computer system) for processing. This indication message may include information such as, for example, prescriber userid, selected resource items and patient information, date, time and IP address.

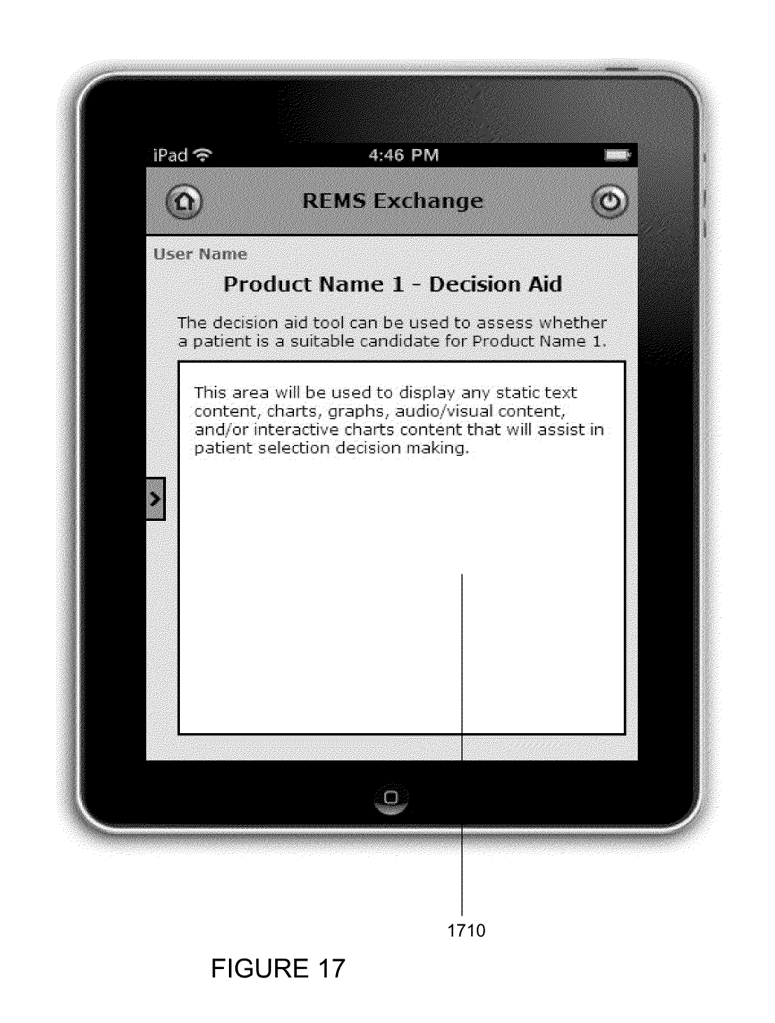

As another example of presentation of selected REMS features (act 424), the healthcare professional may select the decision aid feature. Healthcare professionals may use this feature to learn more about how to select patients for a REMS product, or use the REMS product correctly based on patient attributes such as demographics, history, lifestyle, lab results and more. The decision aid features may be presented to the healthcare professional via, for example, a decision aid page. FIG. 17 depicts an exemplary decision aid page. As shown in FIG. 17, the exemplary decision aid page includes a decision aid presentation field 1710 which may be used to display any content that may assist in patient selection decision making such as, for example, text, charts, graphs, photos, video, other audio/visual content and other information.

As another example of presentation of selected REMS features (act 424), the healthcare professional may select the prescription form creation feature. Healthcare professionals may use this feature to complete any product or class-wide specific activities that must occur with each prescription. The Healthcare professional may first use this feature to search for a previously registered patient. If the application finds a matching patient, then the matching patient may be displayed on the screen. The healthcare professional may then use this feature to create a prescription form for the patient.

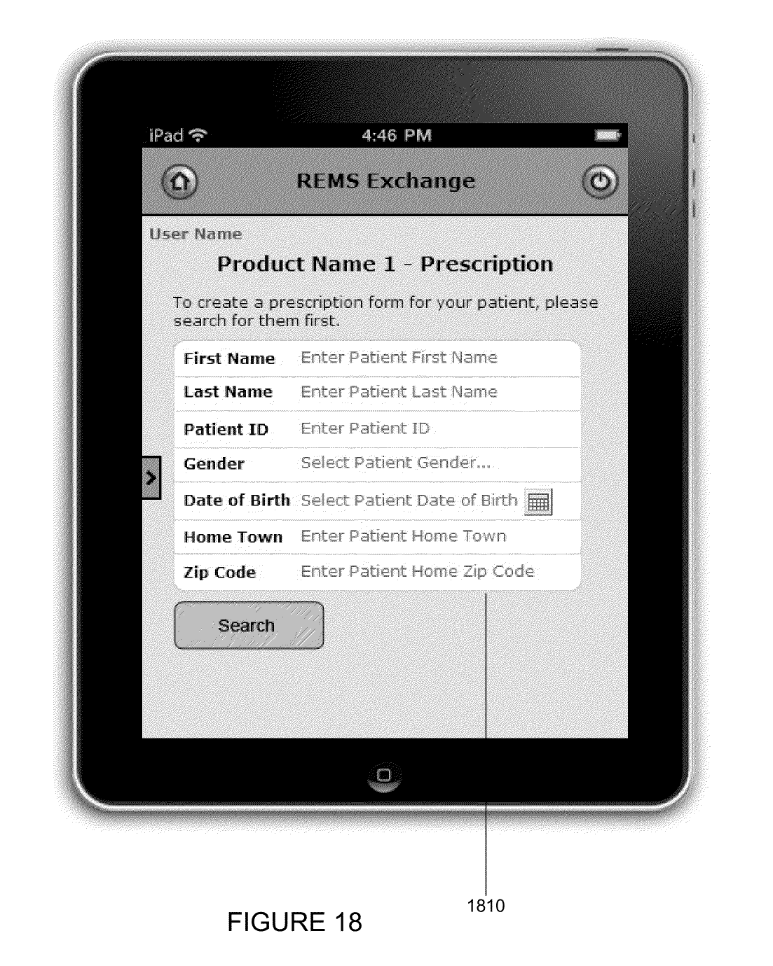

The healthcare professional may search for a registered patient via, for example, a patient search page. FIG. 18 depicts an exemplary patient search page. As shown in FIG. 18, the exemplary patient search page includes patient search input fields 1810 which allow the healthcare professional to input patient search information such as, for example, name, identification number, gender, date of birth, home town, zip code.

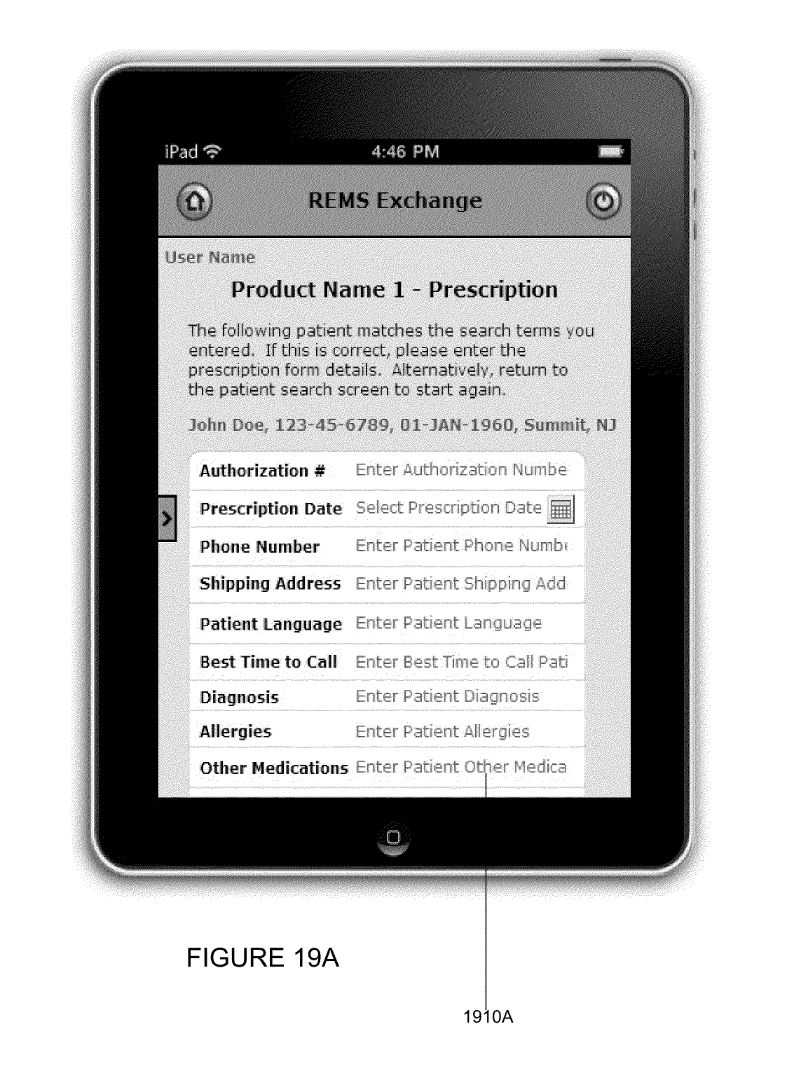

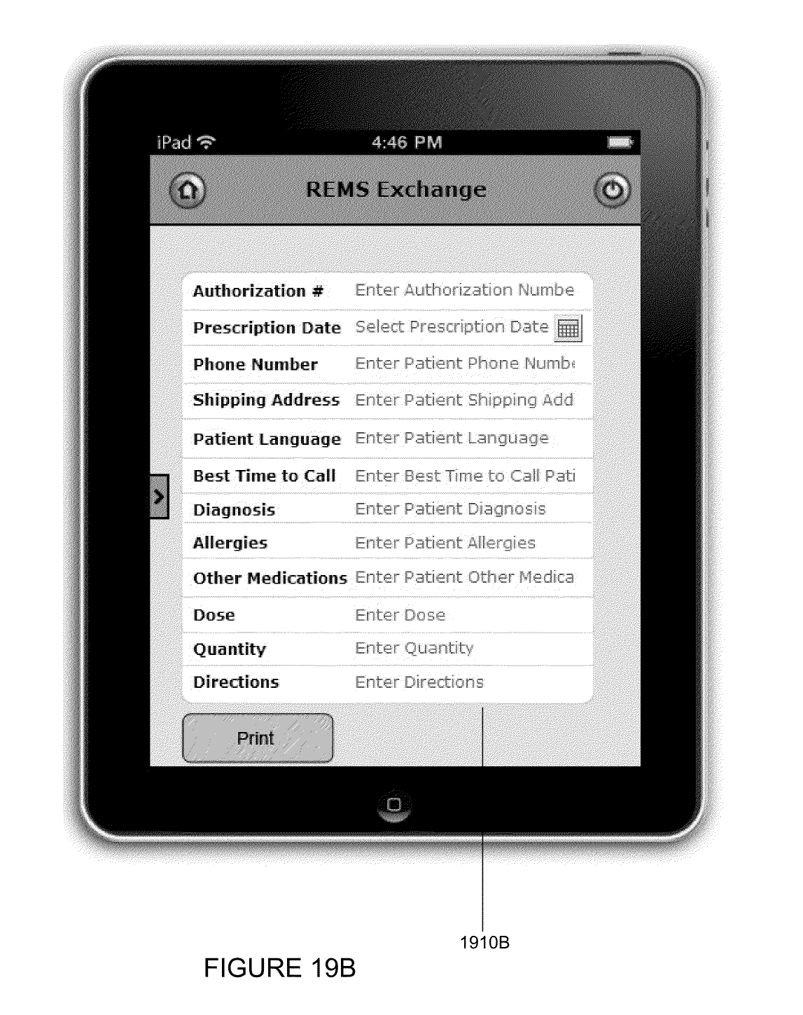

After finding the selected patient, the healthcare professional may create the patient's prescription form via, for example, a prescription form creation page. FIGS. 19A and B depict exemplary prescription form creation pages. FIG. 19B may be displayed, for example, after scrolling down on the screen shown in FIG. 19A. As shown in FIGS. 19A and B, the exemplary prescription form creation pages include prescription form creation input fields 1910A and B which allow the healthcare professional to input prescription form information such as, for example, authorization number, prescription date, patient phone number, patient shipping address, patient language, best time to call patient, patient diagnosis, patient allergies, patient other medications, dose, quantity and directions.

As another example of sending an indication of action performance by a healthcare professional (act 426), an indication of information obtained during the prescription process may be electronically delivered to REMS servers (including, for example, an RMA computer system) for processing. The indication message may include information such as, for example, prescriber userid, patient identifier, medical test date and results, intended prescription (dose and duration), confirmation of understanding regarding product risks, confirmation that specific information has been provided to the patient, date, time, IP address. The REMS servers may return an electronic message to the healthcare professional's client application indicating whether the request was successful or not, along with any appropriate messages that should be displayed to the healthcare professional.

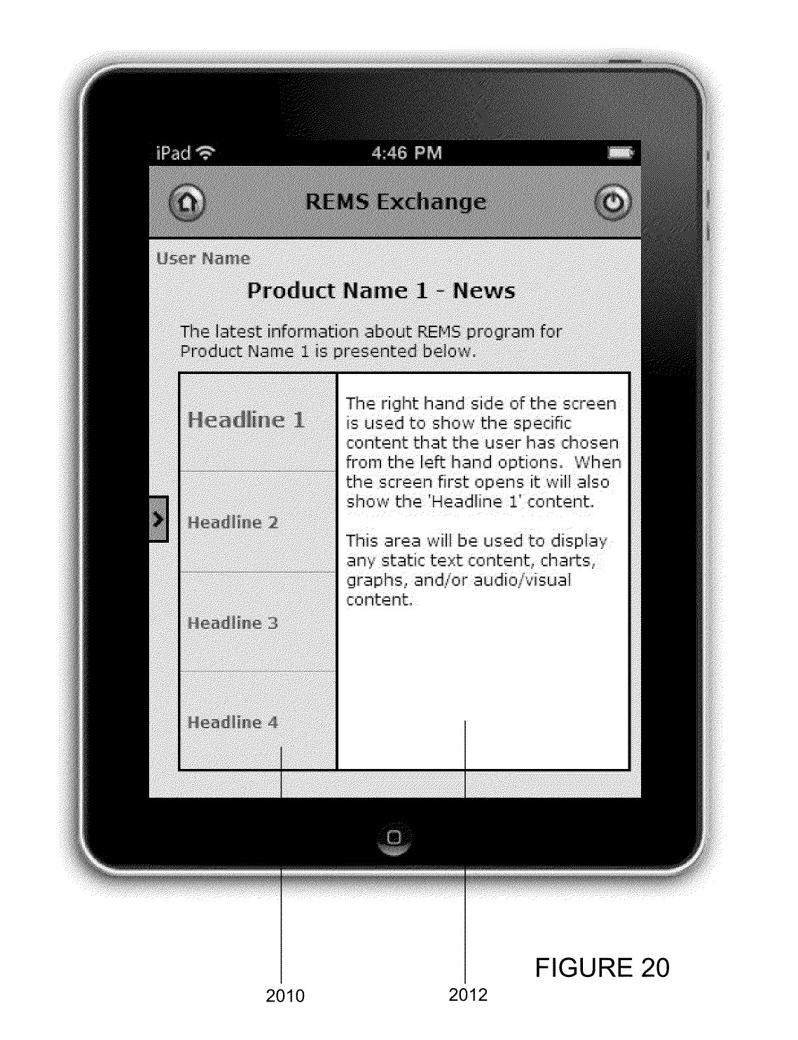

As another example of presentation of selected REMS features (act 424), the healthcare professional may select the news feature. Healthcare professionals may use this feature to obtain the latest information about a specific REMS program. News features may be presented via, for example, a news page. FIG. 20 depicts an exemplary news page. As shown in FIG. 20, the exemplary news page includes a headline selection menu 2010 and a headline presentation field 2012. Headline selection menu 2010 may be used to select a particular headline for display in the headline presentation field 2012. The headline presentation field 2012 may display content corresponding to the selected headline such as, for example, text, charts, graphs, photos, video, other audio/visual content and other information.

As another example of sending an indication of action performance by a healthcare professional (act 426), an indication of presented news or headlines may be electronically delivered to REMS servers (including, for example, an RMA computer system) for processing. The indication message may include information such as, for example, prescriber userid, content viewed, date, time and IP address.

### Exemplary Features for Patients

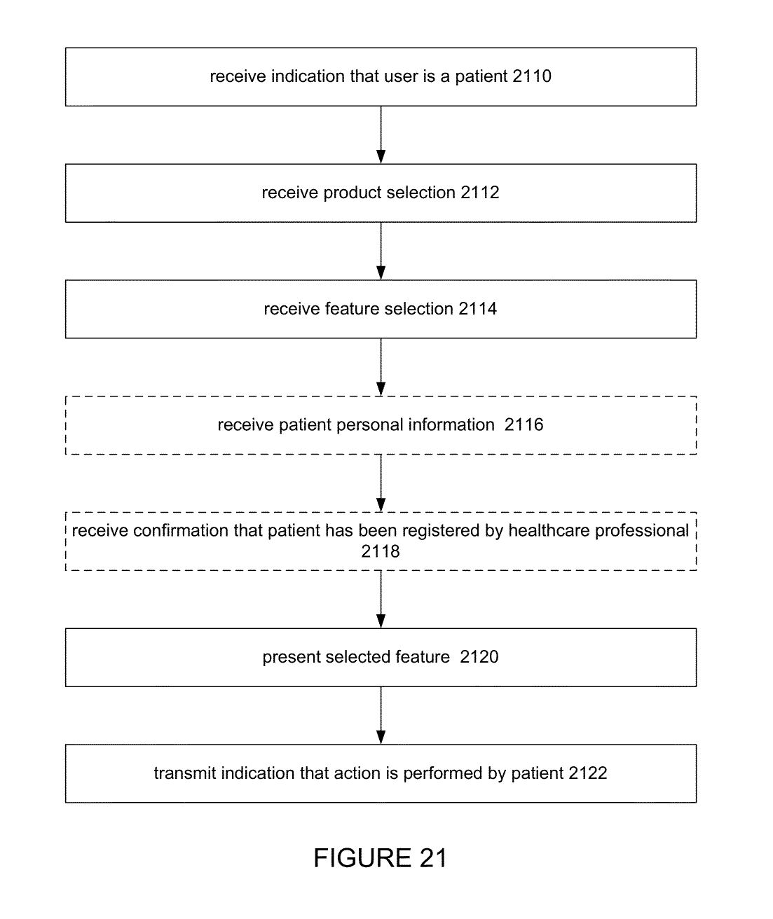

FIG. 21 is a flowchart depicting an exemplary method for presenting REMS related features to a patient. The acts depicted in FIG. 21 may, although need not necessarily, be performed by REMS exchange client software. Such software may, although need not necessarily, be installed on a mobile device such as a smart phone or tablet computer. Such software may be purchased or obtained via an architecture such as depicted in FIG. 2 and described above. Such software may communicate with one or more REMS servers via an architecture such as depicted in FIGS. 3A and 3B and described above.

At act 2110 of FIG. 21, an indication is received that a user is a patient. Such an indication may be received via a REMS exchange application home page. FIG. 5 depicts an exemplary REMS exchange application home page. As shown in FIG. 5, the user may select button 512 to indicate that he is a patient.

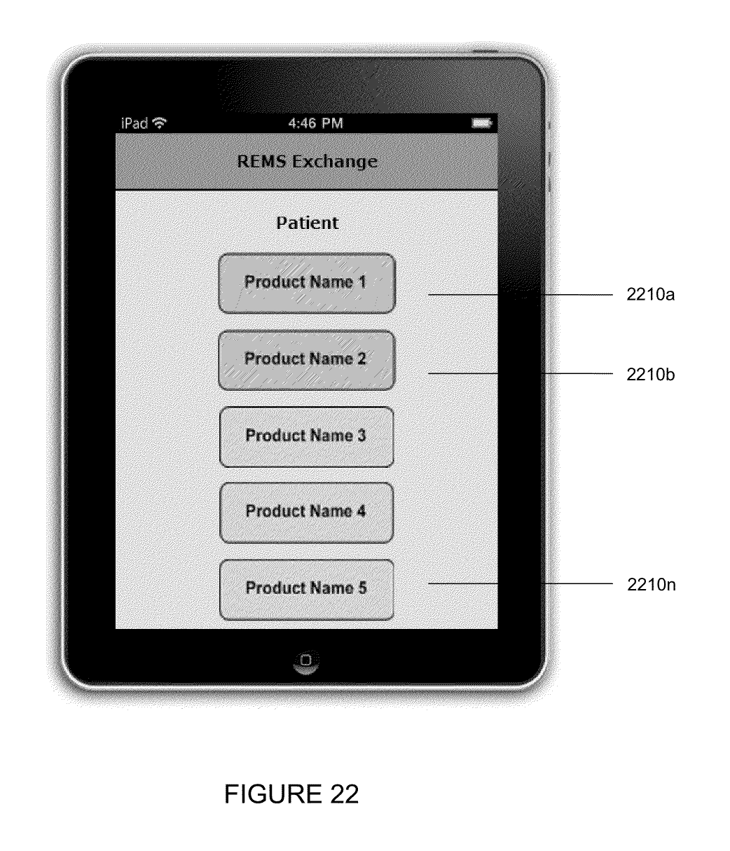

At act 2112, a selection of an available product is received. The selection of an available product may be obtained via a product selection page. FIG. 22 depicts an exemplary patient product selection page. As shown in FIG. 22, buttons 2210a-n are displayed, each corresponding to a particular product. A product may be selected, for example, by pushing its corresponding button. The available products may be, for example, new drug application (NDA) or supplemental new drug applications (sNDA) products. Additionally, each available product selection may correspond to only a single product or to a class or other grouping of products.

When a patient accesses any of the available REMS products, an indication of this activity may be electronically delivered to REMS servers (including, for example, an RMA computer system) for processing. The indication message may include information such as, for example, product selected, content viewed, date, time and IP address.

After receiving a product selection, then one or more available REMS features associated with the selected product may be presented to the patient. Information regarding these features may be transmitted from the REMS servers to the client device. The information may be transmitted to the client device upon confirmation of the product authorization information and/or at other times such as, for example, via periodic updates. The information may also be stored locally at the client device.

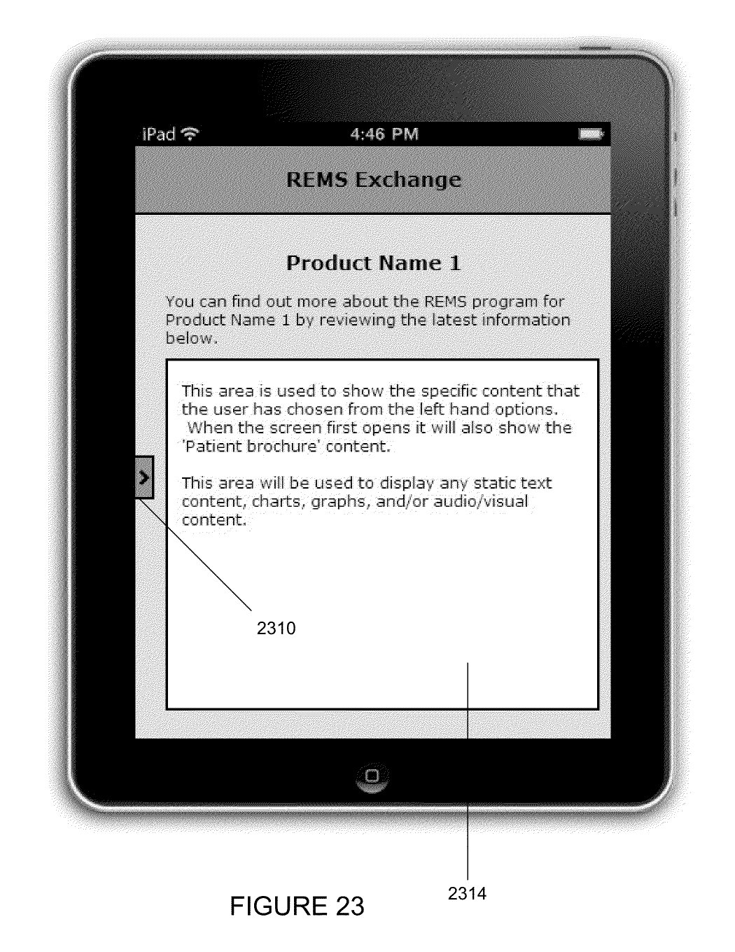

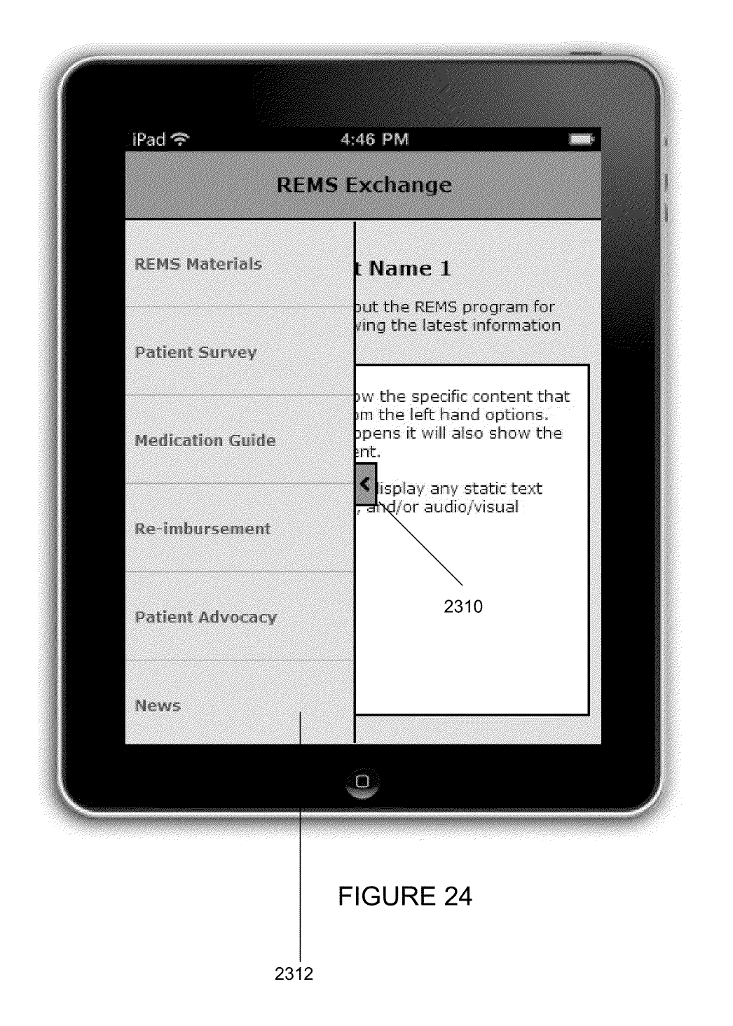

The REMS features may be presented to the patient via, for example, a patient product page with a sliding menu. FIG. 23 depicts an exemplary product page with a retracted sliding menu. The retracted sliding menu can be expanded by, for example, pressing on and dragging menu activation button 2310 to the right. FIG. 24 depicts an exemplary patient product page with an expanded sliding menu 2312. The expanded sliding menu can be retracted by, for example, pressing on and dragging menu activation button 2310 to the left. As shown in FIG. 24, sliding menu 2312 lists a number of available REMS features including, for example, patient education material (referred to in FIG. 24 as “REMS Materials”), a patient survey, a patient medication guide, a reimbursement assistance application and patient support information, information from disease appropriate patient advocacy groups and news. Other features such as, for example, indication specific content may also be made available. Each such REMS feature may be selected by, for example, pressing on the corresponding menu button.

When the patient selects one of the available REMS features (act 2114), the selected REMS feature is then presented to the patient at act 2120. Intervening acts 2116 and 2118 may be optional depending upon the selected feature (as indicated by dashed lines) and are described later in this document with respect to the patient survey feature. It should be appreciated, however, that these acts may be required as a prerequisite to allow the patient to access any or all of the available patient features. Additionally, it should be appreciated that these acts may be performed at any time and in any order. For example, these acts may be performed immediately after receiving an indication that the user is a patient (act 2110). Furthermore, the products and/or features may available to the patient may depend upon the patient being registered.

As an example of presenting the selected REMS feature to the patient at act 2120, the patient may select the educational materials feature (referred to in FIG. 24 as “REMS materials”). The educational materials feature may be presented to the healthcare professional via, for example, the patient product page of FIG. 23. As shown in FIG. 23, the exemplary patient product page includes an educational materials presentation area 2314 that may be used to display the patient educational materials. Educational materials presentation area 2314 may display content such as, for example, text, charts, graphs, photos, video, other audio/visual content and other information.

When a patient performs an action with respect to one of the available REMS features, an electronic communication may be sent to the REMS servers (including, for example, an RMA computer system) at act 2122. The indication message may include information such as, for example, content viewed, date, time and IP address. For example, such a message may be sent when the patient views REMS educational materials. Controls may be employed within the software to ensure that the patient has sufficiently interacted with the corresponding feature before the indication is sent. For example, if the patient is presented with a video, the software may first determine that the entire video has been played before sending the indication to the servers.

As another example of presentation of selected REMS features (act 2120), the patient may select the patient survey features. Patients may use these features to complete any product or class-wide specific activities that must occur with each prescription.

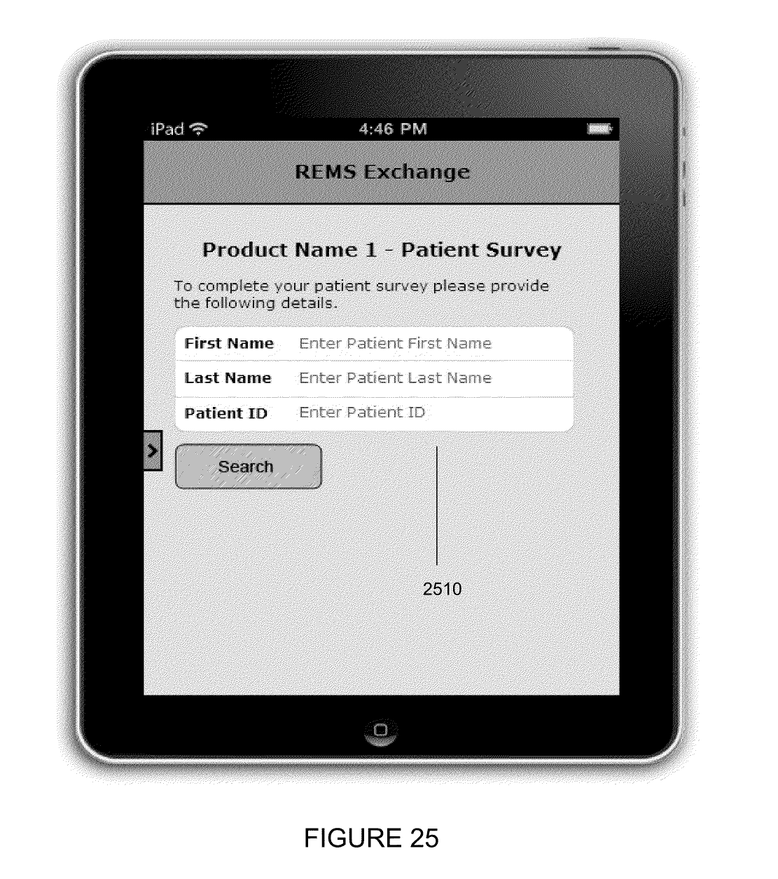

After selecting the patient survey feature, a patient may be prompted to enter personal information. The patient personal information is received at act 2118 of FIG. 21. The patient may enter personal information via, for example, a patient personal information entry page. An exemplary patient personal information entry page is shown in FIG. 25. As shown in FIG. 25, the exemplary patient personal information entry page includes exemplary patient personal information entry fields 2510 including first name, last name and patient ID number. Other forms of personal information may also be used. Upon entry, the personal information may be sent to the REMS servers for comparison against stored patient personal information provided by healthcare professionals during the patient registration process.

If the personal information supplied by the patient does not match stored personal information for any of the previously registered patients, the patient may be prompted to re-enter his personal information or the patient may be denied further access to the patient survey.

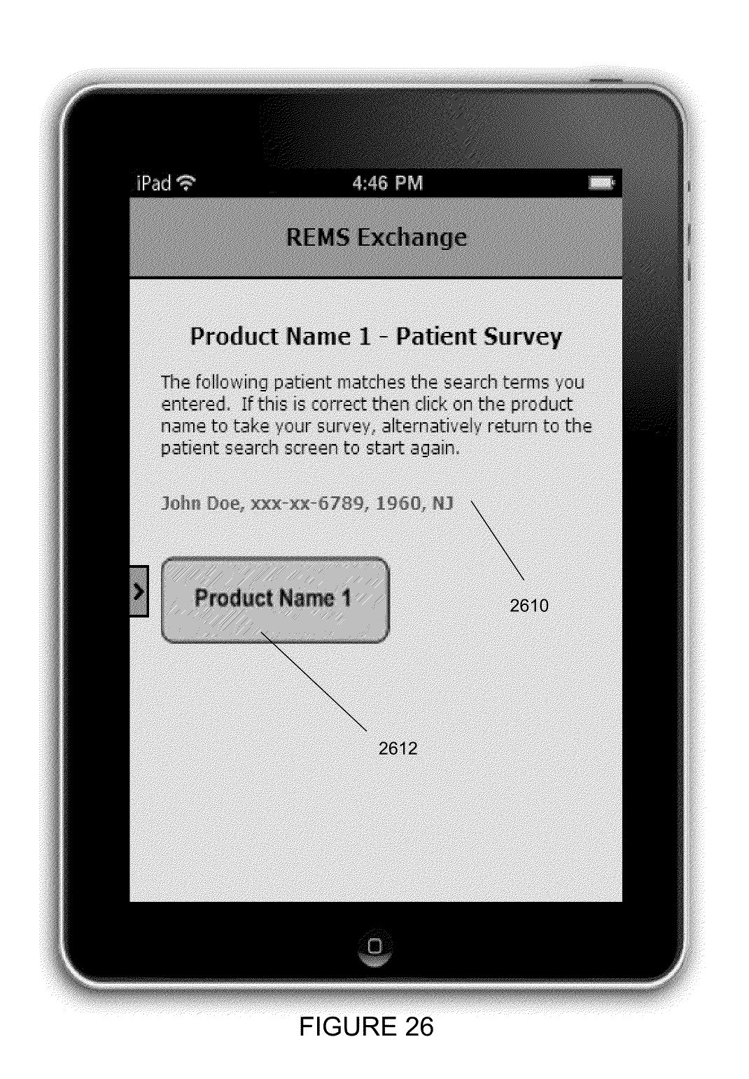

If, on the other hand, a confirmation is received indicating that the personal information supplied by the patient matches stored personal information for one of the previously registered patients (act 2120 of FIG. 21), then a survey product selection page may be displayed. An exemplary survey product selection page is shown in FIG. 26. As shown in FIG. 26, the exemplary survey product selection page includes a survey product selection field 2612. This field may include one or more buttons, each associated with a different product or class of products. The exemplary survey product selection page also includes a personal information display field 2610 that displays the patient's personal information.

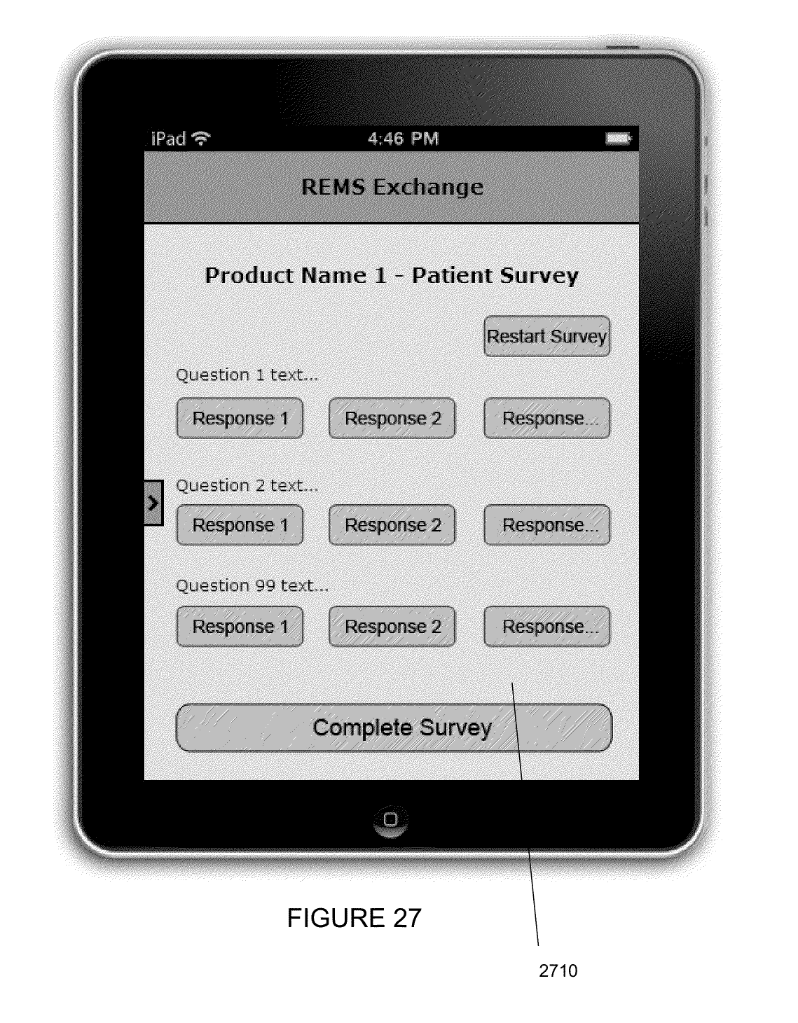

After product survey selection, a patient survey response page may be displayed. An exemplary patient survey response page 2710 is depicted in FIG. 27. As shown, exemplary patient survey response page 2710 includes a number of questions and a group of respective multiple choice response options corresponding to each question. In addition to multiple choice, other forms of response options may be used such as, for example, text input fields. Exemplary patient survey response page 2710 also includes a complete survey button and a restart survey button.

As another example of sending an indication of action performance by a patient (act 2122), survey responses may be electronically transmitted to the REMS servers (including, for example, an RMA computer system) for evaluation. The data included in this message may include, for example, patient ID number, medical test date and results, confirmation of understanding regarding product risks, date, time, IP address and more. The REMS servers may return an electronic message to the client application indicating whether the survey response and information was successfully received, along with any appropriate messages that should be displayed to the patient.

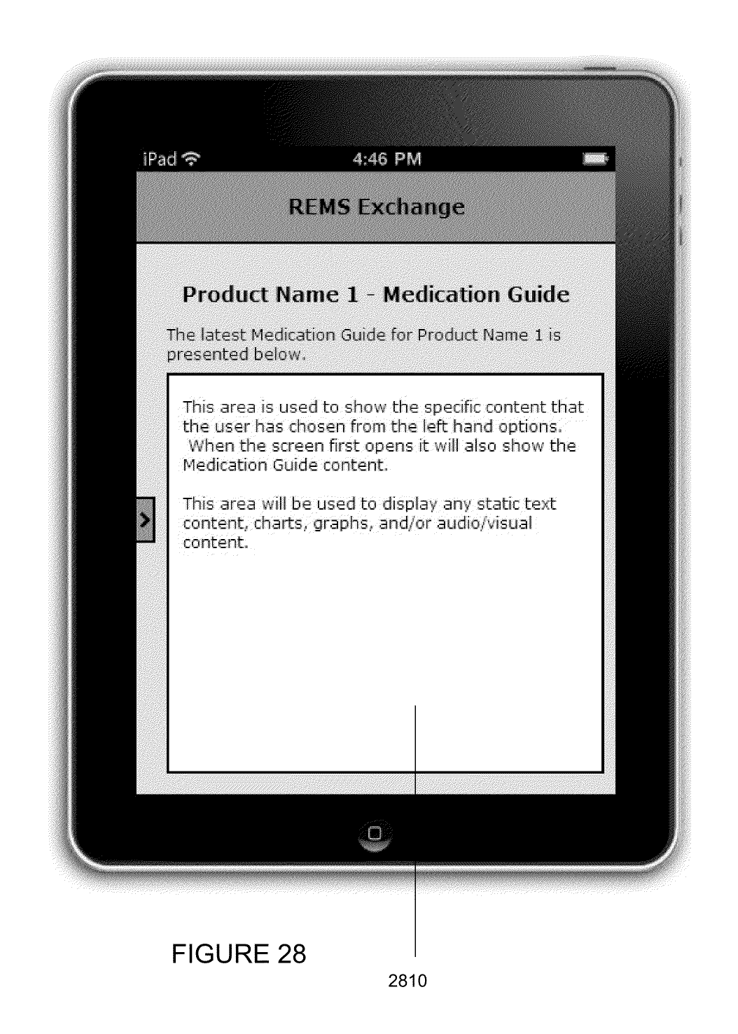

As another example of presentation of selected REMS features (act 2120), the patient may select the patient medication guide features. Patients may use these features to review the product specific Medication Guide, or multiple products if they are interacting with a class-wide REMS. This feature may include, for example, content from the FDA approved product Medication Guide, and/or it may include FDA Office of Prescription Drug Promotion approved audio or video material targeted for patients. The patient medication guide may be presented via, for example, a patient medication guide page. An exemplary patient medication guide page is shown in FIG. 28. As shown in FIG. 28, the exemplary patient medication guide page includes patient medication guide presentation area 2810. Patient medication guide presentation area 2810 may display content such as, for example, text, charts, graphs, photos, video, other audio/visual content and other information.

As another example of sending an indication of action performance by a patient (act 2122), an indication message may be sent to the REMS servers (including, for example, an RMA computer system) to indicate when a patient has accessed medication guide information. The data included in this message may include, for example, date, time, IP address, content viewed, duration and more.

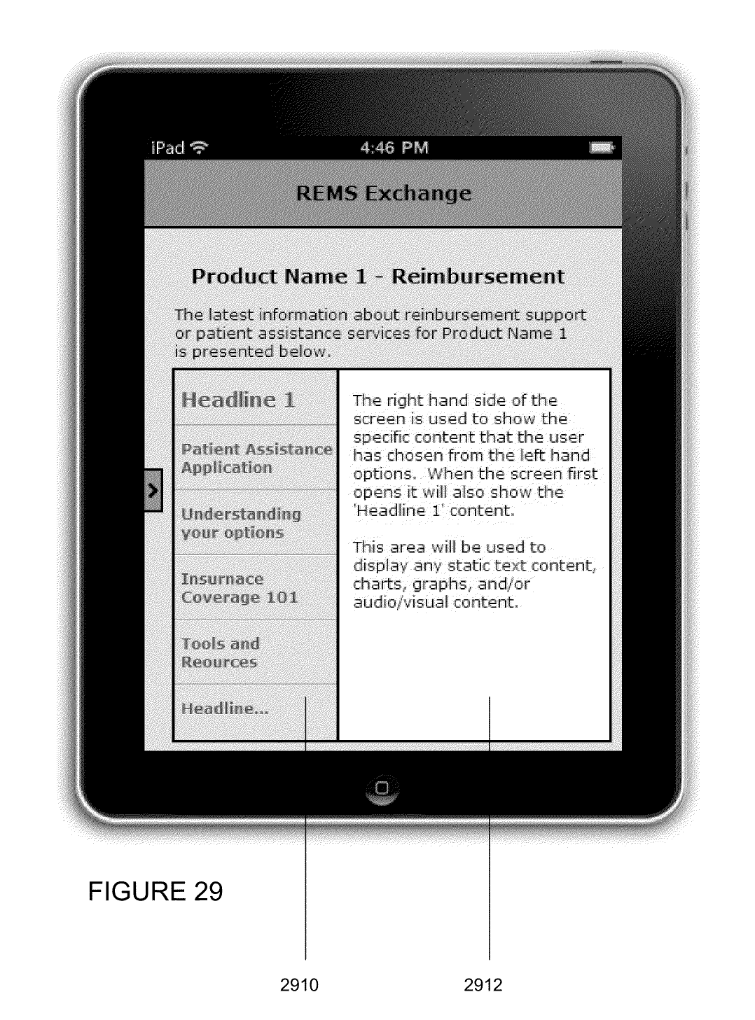

As another example of presentation of selected REMS features (act 2120), the patient may select the re-imbursement features. Patients may use these features to obtain information about re-imbursement support or patient assistance services available for the particular REMS product. The re-imbursement features may be presented via, for example, a re-imbursement page. An exemplary re-imbursement page is shown in FIG. 29. As shown in FIG. 29, the exemplary re-imbursement page includes re-imbursement and patient assistance topics menu 2910 and re-imbursement and patient assistance presentation area 2912. Re-imbursement and patient assistance topics menu 2910 includes a listing of re-imbursement and patient assistance topics that may be selected. After a topic is selected, it may be displayed in re-imbursement and patient assistance presentation area 2912. Re-imbursement and patient assistance presentation area 2912 may display content such as, for example, text, charts, graphs, photos, video, other audio/visual content and other information.

As another example of sending an indication of action performance by a patient (act 2122), an indication message may be sent to the REMS servers (including, for example, an RMA computer system) to indicate when a patient has accessed re-imbursement and patient assistance topics. The data included in this message may include, for example, date, time, IP address, content viewed, duration and more.

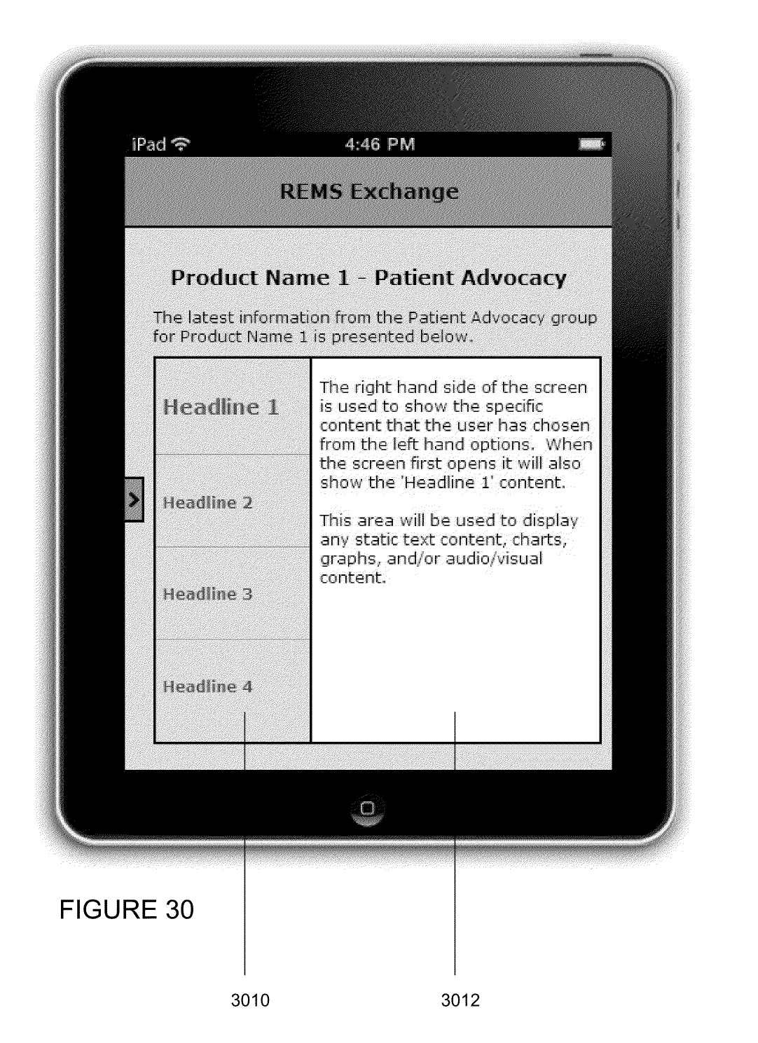

As another example of presentation of selected REMS features (act 2120), the patient may select the patient advocacy features. Patients may use these features to obtain the latest information from the appropriate patient advocacy group regarding the approved indication(s) for the REMS product. The patient advocacy may be presented via, for example, a patient advocacy page. An exemplary patient advocacy page is shown in FIG. 30. As shown in FIG. 30, the exemplary patient advocacy page includes patient advocacy headlines menu 3010 and patient advocacy presentation area 3012. Patient advocacy headlines menu 3010 includes a listing of patient advocacy topics that may be selected. After a topic is selected, it may be displayed in patient advocacy presentation area 3012. Patient advocacy presentation area 3012 may display content such as, for example, text, charts, graphs, photos, video, other audio/visual content and other information.

As another example of sending an indication of action performance by a patient (act 2122), an indication message may be sent to the REMS servers (including, for example, an RMA computer system) to indicate when a patient has accessed patient advocacy topics. The data included in this message may include, for example, date, time, IP address, content viewed, duration and more.

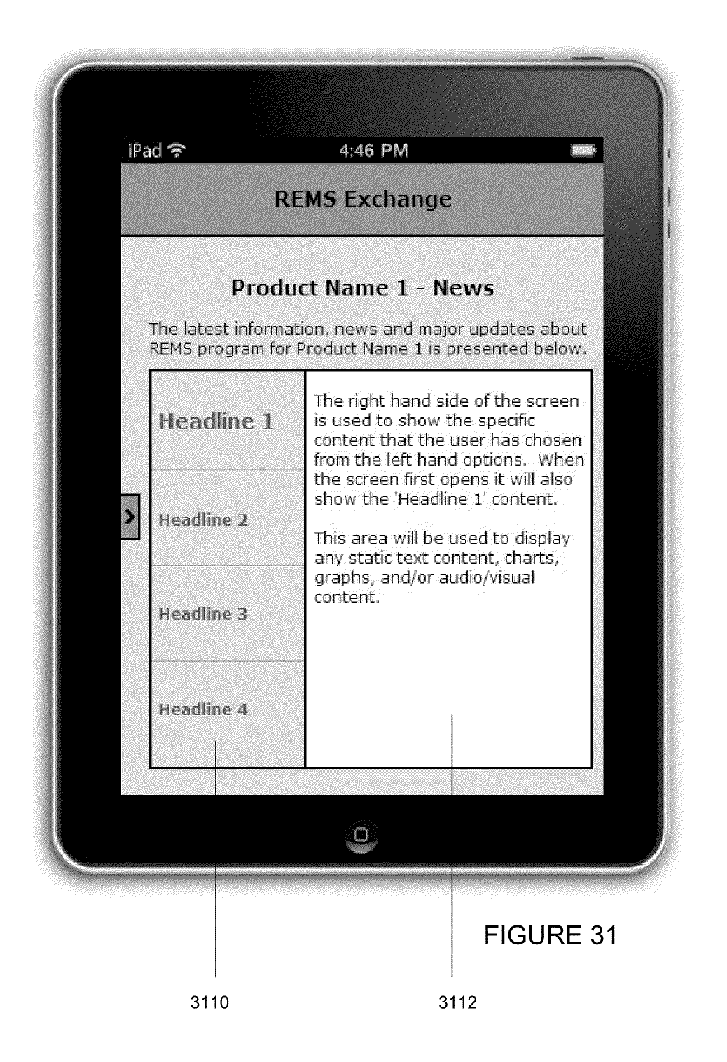

As another example of presentation of selected REMS features (act 2120), the patient may select the news features. Patients may use these features to obtain the latest information about the specific REMS program. The news may be presented via, for example, a patient news page. An exemplary patient news page is shown in FIG. 31. As shown in FIG. 31, the exemplary patient news page includes news headlines menu 3110 and news presentation area 3112. News headlines menu 3110 includes a listing of news topics that may be selected. After a topic is selected, it may be displayed in news presentation area 3112. News presentation area 3012 may display content such as, for example, text, charts, graphs, photos, video, other audio/visual content and other information.

As another example of sending an indication of action performance by a patient (act 2122), an indication message may be sent to the REMS servers (including, for example, an RMA computer system) to indicate when a patient has accessed news topics. The data included in this message may include, for example, date, time, IP address, content viewed, duration and more.

### Exemplary Server-Related Processes

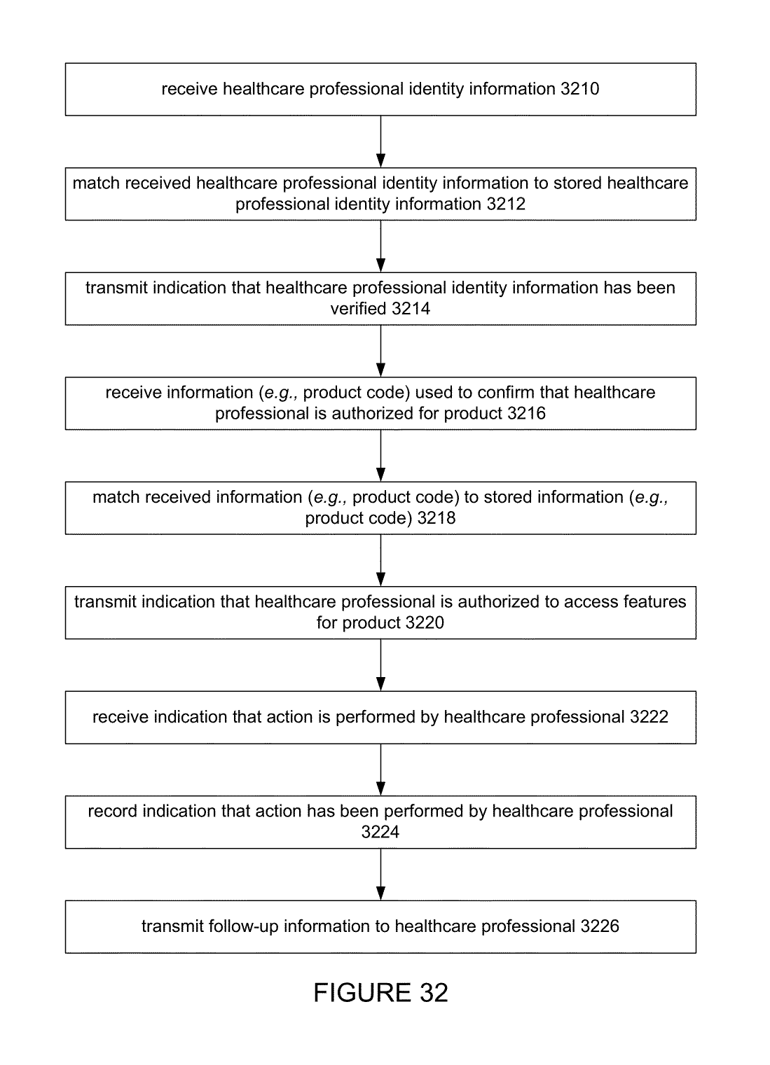

FIG. 32 is a flowchart depicting an exemplary method for interacting with a healthcare professional. The method depicted in FIG. 32 may, although need not necessarily, be performed by one or more servers such as any one or more of the REMS servers described above with reference to FIG. 3. As set forth above, such servers may be operated in whole or in part by, for example, a pharmaceutical company and/or new drug application (NDA) or supplemental new drug application (sNDA) holder, a Risk Management Administrator (RMA), a government agency, another third party, or by any combination of any of the above entities.

At act 3210, healthcare professional identity information is received. For example, such information may be received from a mobile device operated by the healthcare professional. The information may be transmitted by the mobile device over a network such as, for example, the Internet. After receiving this information, a server may compare this identity information to a database of stored healthcare professional profiles. At act 3212, the received identity information may be matched to previously stored healthcare professional identity information. At act 3214, a confirmation may then be transmitted to the healthcare professional's device to indicate that the healthcare profession identity information has been verified. If, however, the received identity information cannot be matched to any stored identity information, then a failure message may be transmitted back to the healthcare professional's device.

Alternatively, if the healthcare professional is registering for the first time, then a server may simply store the received information without comparing it to any previously stored information. The server may, however, attempt to ensure that the information is valid prior to storing it. The server may also return a message indicating that the healthcare professional has successfully registered.

At act 3216, information used to confirm that healthcare professional is authorized for a product is received. For example, such information may also be received from the mobile device operated by the healthcare professional. The information may be transmitted by the mobile device over a network such as, for example, the Internet. Such information may include, for example, a product code. After receiving this information, a server may compare this identity information to a database of stored product codes. At act 3218, the received information may be matched to previously stored information to confirm that the healthcare professional is authorized for the selected product. At act 3220, a confirmation may then be transmitted to the healthcare professional's device to indicate that the healthcare professional is authorized for the selected product. If, however, the received information cannot be matched to any stored information, then a failure message may be transmitted back to the healthcare professional's device.

At act 3222, an indication may be received that an action is performed by healthcare professional. For example, such an indication may also be received from the mobile device operated by the healthcare professional. The indication may be transmitted by the mobile device over a network such as, for example, the Internet. For example, the indication message may indicate that the healthcare professional has accessed an educational materials item, completed a training procedure, registered a patient for the pharmaceutical product, indicating that materials will be delivered to a patient, accessed a decision aid item, created a prescription form, accessed a program news item or accessed a prescribing information item.

At act 3224, an indication that the action has been performed by the healthcare professional may be recorded in, for example, a database. For example, an indication may be recorded that a healthcare professional has registered a patient for a particular product, and the patient's personal information may also be stored as well.

At act 3226, follow-up information may be transmitted back to the healthcare professional's device. For example, if the healthcare professional has completed a training item, then a response indicating success or failure of the training item may be transmitted. If the participant achieved a passing grade, then a unique key code may also be transmitted that may be used in other REMS electronic transactions to indicate that the healthcare professional is qualified to conduct such a transaction.

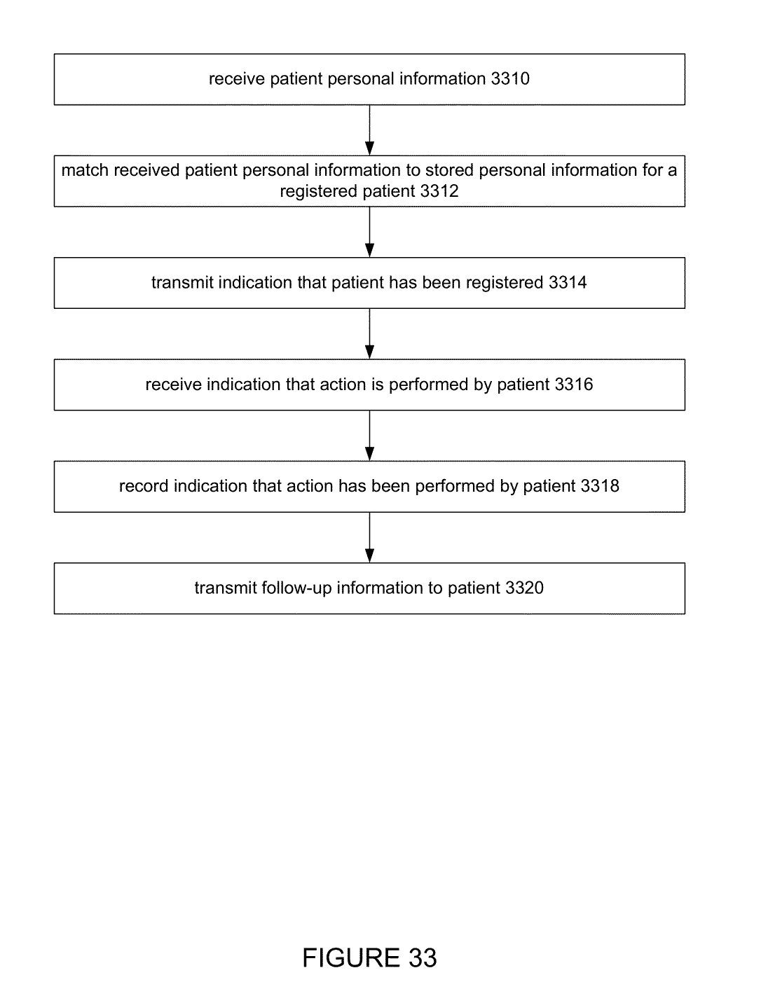

FIG. 33 is a flowchart depicting an exemplary method for interacting with a patient. The method depicted in FIG. 33 may, although need not necessarily, be performed by one or more servers such as any one or more of the REMS servers described above with reference to FIG. 3. As set forth above, such servers may be operated in whole or in part by, for example, a pharmaceutical company, a government agency, a Risk Management Administrator (RMA), another third party, or by any combination of any of the above entities.

At act 3310, patient personal information is received. For example, such information may be received from a mobile device operated by the patient. The information may be transmitted by the mobile device over a network such as, for example, the Internet. After receiving this information, a server may compare this personal information to a database of stored profiles for patients that have been previously registered by a healthcare professional. At act 3312, the received personal information may be matched to previously stored personal information for a registered patient. At act 3314, a confirmation may then be transmitted to the patient's device to indicate that the patent's personal information has been verified. This confirmation may include the matched patient's personal information and also an indication of products for which that patient has been registered. If, however, the received personal information cannot be matched to any stored personal information, then a failure message may be transmitted back to the patient's device.

At act 3316, an indication may be received that an action is performed by patient. For example, such an indication may also be received from the mobile device operated by the patient. The indication may be transmitted by the mobile device over a network such as, for example, the Internet. For example, the indication message may indicate that the patient has accessed an educational materials item, accessed a patient support information or reimbursement item, accessed a patient advocacy group item, completed a patient survey item, accessed a patient medication guide item, or accessed a program news item.

At act 3318, an indication that the action has been performed by the patient may be recorded in, for example, a database. For example, an indication may be recorded that a patient has completed a survey item along with the results of the survey.

At act 3320, follow-up information may be transmitted back to the patient's device. For example, if the patient has completed a survey item, then a response indicating that the survey response was successfully recorded may be sent back to the patient.

### CONCLUSION

In addition to the techniques described above, other features for collecting and transmitting information may also be employed. For example, in addition to or in combination with the user interfaces described above, electronic files may also be provided and transmitted by healthcare professionals, patients and others using the applications described herein. The applications described herein may, for example, allow a user to search a device or connected devices to identify a relevant electronic file and to obtain the file and transmit the file to REMS servers, healthcare professional or patient devices, or any other devices. The user interface may provide instructions for transmitting or uploading such files including identifying relevant file types, formats and communications protocols, acceptable file sizes, required header information and formats, conversion techniques, or any other relevant information. If a collection of information is not in electronic format, instructions may be provided for converting the information to electronic format such as by using a scanning device.

Such electronic files may include information relevant to pharmaceutical products, REMS related features and other information. For example, such files may include patient files, product files, healthcare professional files, files about groups or classes of the previously listed files and other files. Such files may include information such as personal information about the patient, personal health history, family health history, any relevant medical conditions, information about a course of treatment and the patient's interaction with the pharmaceutical product, information for a prescription form, information about groups and/or classes of patients or any other relevant information. Such files may include a patient or healthcare professional survey, brochures, patient interviews or any other relevant collection of information. Such files may include, for example, text, charts, graphs, photos, video, other audio/visual content and other information.

Upon receiving an electronic file, the file may be authenticated, scanned for viruses or other threats, may be checked for validity, may be converted to a necessary format or any other necessary procedure. A file may also be parsed and examined for errors such as, for example, invalid or improper information. A communication may then be issued to the sender of the file to identify the errors and to give the sender the opportunity to correct the errors and/or provide additional information. Error correction and additional information need not necessarily require a re-transmission of the entire file. For example, only necessary portions of the file may be re-sent or a custom user interface may be provided for obtaining the necessary information without requiring uploading of a file.

While example embodiments of devices for executing the disclosed techniques are described herein, the underlying concepts can be applied to any computing device, processor, or system capable of communicating and presenting information as described herein. The various techniques described herein can be implemented in connection with hardware or software or, where appropriate, with a combination of both. Thus, the methods and apparatuses described herein can be implemented, or certain aspects or portions thereof, can take the form of program code (i.e., instructions) embodied in tangible storage media, such as floppy diskettes, CD-ROMs, hard drives, or any other machine-readable storage medium (computer-readable storage medium), wherein, when the program code is loaded into and executed by a machine, such as a computer, the machine becomes an apparatus for performing the techniques described herein. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The techniques described herein also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for determining propagation time. When implemented on a general-purpose processor, the program code combines with the processor to provide a unique apparatus that operates to invoke the functionality described herein. Additionally, any storage techniques used in connection with the techniques described herein can invariably be a combination of hardware and software.

While the techniques described herein can be implemented and have been described in connection with the various embodiments of the various figures, it is to be understood that other similar embodiments can be used or modifications and additions can be made to the described embodiments without deviating therefrom. For example, one skilled in the art will recognize that the techniques described in the present application may apply to any environment, whether wired or wireless, and may be applied to any number of such devices connected via a communications network and interacting across the network. Therefore, the techniques described herein should not be limited to any single embodiment, but rather should be construed in breadth and scope in accordance with the appended claims.

What is claimed:

1. A computer readable storage medium having stored thereon computer executable instructions for performing acts comprising:
receiving a verification of an identity of a healthcare professional;
receiving a confirmation that the healthcare professional is authorized to access features associated with a pharmaceutical product; and
presenting the features associated with the pharmaceutical product to the healthcare professional.

2. The computer readable storage medium of claim 1, wherein the features correspond to risk evaluation and mitigation strategy (REMS).

3. The computer readable storage medium of claim 1, wherein the acts further comprise configuring the features for presentation using a mobile device.

4. The computer readable storage medium of claim 1, wherein receiving a confirmation that the healthcare professional is authorized to access features associated with a pharmaceutical product comprises:
receiving a product code entered by the healthcare professional; and
receiving a confirmation that the code entered by the healthcare professional has been verified.

5. The computer readable storage medium of claim 1, wherein the features are associated with a class of pharmaceutical products.

6. The computer readable storage medium of claim 1, wherein the features comprise one or more of prescribing information, educational materials, training, survey and knowledge assessment, patient registration, patient resources, decision aid, prescription form creation and news.

7. The computer readable storage medium of claim 1, wherein the acts further comprise receiving an indication that a user is a healthcare professional.

8. The computer readable storage medium of claim 1, wherein the acts further comprise transmitting an indication that the healthcare professional has performed an action corresponding to the features.

9. The computer readable storage medium of claim 8, wherein the action comprises accessing an educational materials item.

10. The computer readable storage medium of claim 8, wherein the action comprises completing a training procedure.

11. The computer readable storage medium of claim 8, wherein the action comprises registering a patient for the pharmaceutical product.

12. The computer readable storage medium of claim 8, wherein the action comprises indicating that materials will be delivered to a patient.

13. The computer readable storage medium of claim 8, wherein the action comprises accessing a decision aid item.

14. The computer readable storage medium of claim 8, wherein the action comprises creating a prescription form.

15. The computer readable storage medium of claim 8, wherein the action comprises accessing a program news item.

16. The computer readable storage medium of claim 8, wherein the action comprises accessing a prescribing information item.

17. The computer readable storage medium of claim 1, wherein at least some of the features are made available only to healthcare professionals.

18. A method for presentation of features associated with a pharmaceutical product comprising:
receiving, by one or more computing devices, a verification of an identity of a healthcare professional;
receiving, by the one or more computing devices, a confirmation that the healthcare professional is authorized to access the features associated with the pharmaceutical product; and
presenting, by the one or more computing devices, the features associated with the pharmaceutical product to the healthcare professional.

19. A computer readable storage medium having stored thereon computer executable instructions for performing acts comprising:
receiving an indication that a user is a patient; and
presenting patient-accessible features associated with a pharmaceutical product.

20. The computer readable storage medium of claim 19, wherein the features correspond to risk evaluation and mitigation strategy (REMS).

21. The computer readable storage medium of claim 19, wherein the acts further comprise configuring the features for presentation using a mobile device.

22. The computer readable storage medium of claim 19, wherein the features are associated with a class of pharmaceutical products.

23. The computer readable storage medium of claim 19, wherein the acts further comprise:
receiving personal information entered by the patient that identifies the patient;
receiving confirmation that the personal information entered by the patient matches personal information for a patient registered by a healthcare professional.

24. The computer readable storage medium of claim 23, wherein at least some of the features cannot be accessed by the patient until the confirmation is received.

25. The computer readable storage medium of claim 19, wherein the features comprise one or more of patient education material, patient support information and a reimbursement assistance application, indication specific content, information from disease appropriate patient advocacy groups, a patient medication guide, a patient survey and news.

26. The computer readable storage medium of claim 19, wherein the acts further comprise transmitting an indication that the patient has performed an action corresponding to the features.

27. The computer readable storage medium of claim 26, wherein the action comprises accessing an educational materials item.

28. The computer readable storage medium of claim 26, wherein the action comprises accessing a patient support information or reimbursement item.

29. The computer readable storage medium of claim 26, wherein the action comprises accessing a patient advocacy group item.

30. The computer readable storage medium of claim 26, wherein the action comprises completing a patient survey item.

31. The computer readable storage medium of claim 26, wherein the action comprises accessing a patient medication guide item.

32. The computer readable storage medium of claim 26, wherein the action comprises accessing a program news item.

33. A method for presentation of features associated with a pharmaceutical product comprising:
receiving, by one or more computing devices, an indication that a user is a patient; and
presenting, by the one or more computing devices, patient-accessible features associated with a pharmaceutical product.

34. A computer readable storage medium having stored thereon computer executable instructions for performing acts comprising:
verifying an identity of a healthcare professional;
confirming that the healthcare professional is authorized to access features associated with a pharmaceutical product; and
sending to the healthcare professional information associated with the pharmaceutical product.

35. The computer readable storage medium of claim 34, wherein the information corresponds to risk evaluation and mitigation strategy (REMS).

36. The computer readable storage medium of claim 34, comprising sending to a mobile device the information associated with the pharmaceutical product.

37. The computer readable storage medium of claim 34, wherein confirming that the healthcare professional is authorized to access features associated with a pharmaceutical product comprises:
receiving a product code entered by the healthcare professional; and
verifying that the entered product code matches a stored product code associated with the pharmaceutical product.

38. The computer readable storage medium of claim 34, wherein the acts further comprise receiving an indication that the healthcare professional has performed an action corresponding to the features.

39. The computer readable storage medium of claim 38, wherein the acts further comprise recording an indication of the action in memory.

40. The computer readable storage medium of claim 39, wherein the action comprises registering a patient for the pharmaceutical product and wherein the recording comprises recording in memory an indication that the patient has been registered to use the pharmaceutical product.

41. A computer readable storage medium having stored thereon computer executable instructions for performing acts comprising:
receiving personal information provided by a patient;
matching the personal information provided by the patient to personal information for a registered patient provided by a healthcare professional; and
sending to the patient a confirmation indicating that the patient has been registered.

42. The computer readable storage medium of claim 41, wherein the acts further comprise sending to the patient information associated with a pharmaceutical product.

43. The computer readable storage medium of claim 41, wherein the information corresponds to risk evaluation and mitigation strategy (REMS).

44. The computer readable storage medium of claim 41, comprising sending to a mobile device the information associated with a pharmaceutical product

45. The computer readable storage medium of claim 41, wherein the acts further comprise receiving an indication that the patient has performed an action corresponding to the features.

46. The computer readable storage medium of claim 45, wherein the acts further comprise recording an indication of the action in memory.

47. The computer readable storage medium of claim 1, wherein the acts further comprise receiving or transmitting information associated with the pharmaceutical product using a cloud-based communications network.

48. The computer readable storage medium of claim 1, wherein the acts further comprise:
allowing the healthcare professional to provide an electronic file including information associated with the pharmaceutical product; and
transmitting the electronic file over a network to one or more remote devices.

49. The computer readable storage medium of claim 19, wherein the acts further comprise receiving or transmitting information associated with the pharmaceutical product using a cloud-based communications network.

50. The computer readable storage medium of claim 19, wherein the acts further comprise:
allowing the patient to provide an electronic file including information associated with the pharmaceutical product; and
transmitting the electronic file over a network to one or more remote devices.
